(19) United States
(12) Patent Application Publication
(10) Pub. No.: US 2025/0217974 A1
(43) Pub. Date: Jul. 3, 2025

(54) CERVICAL VERTEBRAL MATURATION ASSESSMENT USING AN INNOVATIVE ARTIFICIAL INTELLIGENCE-BASED IMAGING ANALYSIS SYSTEM

(71) Applicant: University of Louisville Research Foundation, Inc., Louisville, KY (US)

(72) Inventors: Hossam Magdy Balaha, Louisville, KY (US); Ahmed Alksas, Louisville, KY (US); Amine Fattal, Elkhart, IL (US); Toru Deguchi, Louisville, KY (US); Ayman El-Baz, Louisville, KY (US); Amir A. Sewelam, Kafr Saad (EG); Wael Aboelmatty, Riyadh (SA); Khaled Abdel-Ghaffar, El Weili (EG)

(21) Appl. No.: 18/986,488

(22) Filed: Dec. 18, 2024

Related U.S. Application Data
(60) Provisional application No. 63/611,763, filed on Dec. 18, 2023.

(51) Int. Cl. G06T 7/00

(52) U.S. Cl. CPC G06T 7/0012; G06T 2207/20081; G06T 2207/20104; G06T 2207/30012

(57) ABSTRACT

Computer-aided classification systems and methods for prediction of cervical vertebral maturation stages include extracting cervical vertebrae from medical images, parcellating the cervical vertebrae to generate a plurality of iso-contours for each segmented cervical vertebrae, extracting local and global imaging markers that describe the shape and appearance of each extracted cervical vertebrae, and classifying, using a two-stage machine learning classifier, the cervical vertebral maturation stage of the extracted cervical vertebrae.

### CROSS-REFERENCE TO RELATED APPLICATION

This application claims the benefit of priority to U.S. provisional patent application Ser. No. 63/611,763, filed Dec. 18, 2023, for CERVICAL VERTEBRAL MATURATION ASSESSMENT USING AN INNOVATIVE ARTIFICIAL INTELLIGENCE-BASED IMAGING ANALYSIS SYSTEM, incorporated herein by reference.

### FIELD OF THE INVENTION

The present invention relates to computer-aided classification systems and methods for prediction of cervical vertebral maturation (CVM) stages include extracting cervical vertebrae from medical images, parcellating the cervical vertebrae to generate a plurality of iso-contours for each segmented cervical vertebrae, extracting local and global imaging markers that describe the shape and appearance of each extracted cervical vertebrae, and classifying, using a two-stage machine learning classifier, the CVM stage of the extracted cervical vertebrae.

### BACKGROUND OF THE INVENTION

Dental malocclusion, which affects 20%-83% of adolescents and adults, is characterized by misaligned teeth that impair masticatory function and cause aesthetic issues. Especially when considering adolescents, timely actions have the potential to prevent or hinder the progression of malocclusion in its early stages. For effective early intervention, estimating skeletal growth remaining for these patients is a crucial aspect of orthodontic treatment, particularly when jaw growth modification or orthognathic surgery is involved. Over the years, orthodontists have developed and utilized various methods to evaluate the developmental stage of orthodontic patients. In the past, skeletal age was used to determine a child's capacity for growth. More recently, CVM staging and assessment of hand-wrist bone age are utilized by dental practitioners. Adult orthodontic treatment has been increasingly popular in recent years, resulting in a scarcity of data on adolescent patients. Therefore, in order to improve the patient's treatment experience and raise the probability of a successful treatment outcome, medical professionals must expand their understanding of this subgroup.

The need for extra radiographic tests with hand-wrist radiographs has led to hesitation from orthodontists and patients when considering this approach in orthodontic procedures. However, due to the possibility of evaluating CVM stages using lateral cephalograms, which are already essential for orthodontic analysis, the adoption of CVM staging has been increasingly favored within the orthodontic community. Lateral cephalograms are used to analyze the morphological characteristics of the second, third, and fourth cervical vertebrae, aiming to identify potential variations that could be utilized in estimating CVM.

### SUMMARY

The instant invention relates to computer-aided classification systems and methods for prediction of CVM stages. In some embodiments, these predictions are used to guide orthodontic treatments in adolescents by determining the adolescent's capacity for additional growth. Here, an examination was conducted on the structure of the second, third, and fourth cervical vertebrae as depicted in FIG. 1, left panel, using cephalograms from a group of 390 individuals who had not received orthodontic treatment. This examination spanned six successive observations. The novel CVM approach introduced herein encompasses 6 distinct stages of maturation, labeled as cervical stages 1 through 6 (CS1 to CS6). The stages of cervical vertebral maturation are categorized into six stages depending on the vertebrae C2-C4 as presented in FIG. 1, right panel.

During the initial stage (CS1), the lower borders of vertebrae C2-C4 display a flat configuration, while the bodies of C3 and C4 take on a trapezoidal shape. Mandibular development typically peaks around two years after this stage. In stage two (CS2), a concavity emerges at the lower border of C2, and the shapes of the C3 and C4 bodies remain trapezoidal. Mandibular development peaks around one year after this stage. In stage three (CS3), concavities are observable in the lower borders of both C2 and C3. The bodies of C3 and C4 exhibit the possibility of being either trapezoidal or horizontally rectangular in shape. The peak of mandibular development typically occurs within the year following this stage. In stage four (CS4), concavities manifest at the lower borders of C2, C3, and C4. The bodies of C3 and C4 transform into a horizontally rectangular configuration. Mandibular development typically peaked during the previous year or two before this stage. In stage five (CS5), the concavities along the lower borders of C2, C3, and C4 persist. At least one of the bodies of C3 and C4 adopts a square shape, or alternatively, the other cervical vertebra retains a rectangular horizontal form. Typically at least a year has passed since the peak of mandibular development. Finally, in the last stage (CS6), the concavities along the lower borders of C2, C3, and C4 remain discernible. At least one of the bodies of C3 and C4 takes on a vertically rectangular shape, or the other cervical vertebra becomes square. At least two years have passed since the peak of mandibular development.

This invention provides a significant advancement by introducing a system capable of processing medical images, namely, X-ray images and more specifically, lateral cephalograms, and inputs extracted from the medical images, namely, contour markers, first-order markers, second-order markers, distance maps, and iso-contours, to achieve precise classifications of cervical vertebrae. It employs parcellating the cervical vertebrae based on the Marching level-sets approach to generate five iso-contours for each segmented cervical vertebra, extraction of first- and second-order markers in the markers extraction and engineering process, enhancing the system's ability to interpret diverse design elements, and improving performance and interpretability. Use of a multi-stage and multi-level machine learning classification process further refines the system, allowing for detailed analysis and transparent results, benefiting designers' understanding of classification decisions. Overall, this novel CAD system addresses previous limitations and offers an efficient, accurate, and insightful tool for computer-aided design.

It will be appreciated that the various systems and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

A better understanding of the present invention will be had upon reference to the following description in conjunction with the accompanying drawings.

FIG. 1 depicts the C2-C4 vertebrae from different perspectives in the left panel of the figure. The right panel of the figure depicts, top to bottom, representations of the C2-C4 vertebrae. In the left panel are displayed the C2-C4 vertebrae (top to bottom) in the six stages of maturation (left to right, stage 1: pre-pubertal, stage 2: onset of puberty, stage 3: mid-pubertal, stage 4: late puberty, stage 5: post-pubertal, stage 6: adult).

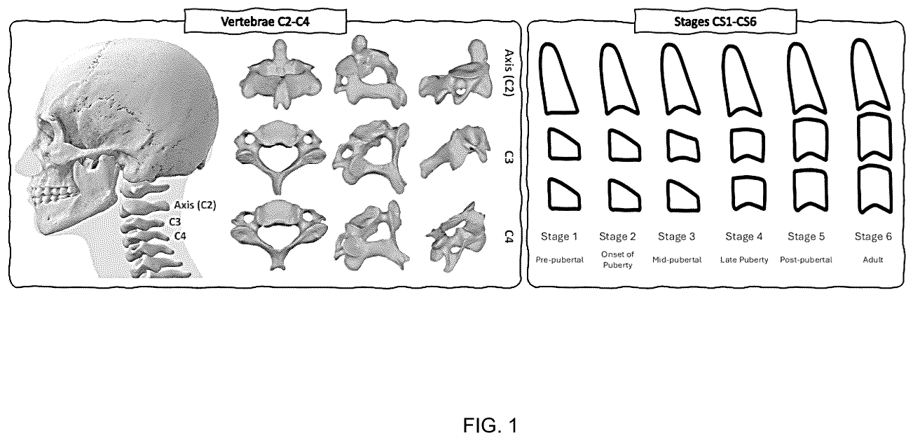

FIG. 2 is a schematic summarizing the disclosed multi-stage and multi-level CAD framework. The stages are, left to right, dataset acquisition, ROI extraction, cervical vertebrae processing, markers extraction, and classification, which is divided into first stage classification and second stage classification.

FIG. 3 depicts original images (top row) and masks (bottom row) from collected and pre-processed cases ordered (left to right) from stage 1 to stage 6 of maturation order.

FIG. 4 is a diagram depicting the U-Net architecture.

FIG. 5 depicts visualization of the marching level-sets aiming to extract the distance maps (i.e., iso-contours), progressing from 25% (leftmost image) to 100% (rightmost image).

FIG. 6 depicts a visualization of the ROI extraction and distance map calculations based on marching level-sets and the pre-processing steps applied on a sample image.

FIG. 7 depicts visualization of contours and second-order markers. For the upper ROI section, this illustration presents marked contours including area, perimeter, centroid, radial distance, aspect ratio, convexity, compactness, extent and solidity. These markers are employed across four distance maps, alongside the visualized GLCM and GLRLM markers.

FIG. 8A is a visualization of the comprehensive confusion matrix subsequent to the application of data to the CAD framework using individual classifiers and with error propagation. Labels on the left indicate the actual maturation stage while labels on the bottom indicate the predicted maturation stage. The colorbar located to the right of the shows a range of values representing the frequency of predictions.

FIG. 8B is a visualization of the comprehensive confusion matrix subsequent to the application of data to the CAD framework using individual classifiers and without error propagation. Labels on the left indicate the actual maturation stage while labels on the bottom indicate the predicted maturation stage. The colorbar located to the right of the shows a range of values representing the frequency of predictions.

FIG. 8C is a visualization of the comprehensive confusion matrix subsequent to the application of data to the CAD framework using combined classifiers and with error propagation. Labels on the left indicate the actual maturation stage while labels on the bottom indicate the predicted maturation stage. The colorbar located to the right of the shows a range of values representing the frequency of predictions.

FIG. 8D is a visualization of the comprehensive confusion matrix subsequent to the application of data to the CAD framework using combined classifiers and without error propagation. Labels on the left indicate the actual maturation stage while labels on the bottom indicate the predicted maturation stage. The colorbar located to the right of the shows a range of values representing the frequency of predictions.

FIG. 9 displays prediction results obtained from the customized U-Net architecture and includes, left-to-right, the original medical image, the specialist-designated ground truth, the prediction results, and the prediction results overlaid on the original medical image.

### DETAILED DESCRIPTION OF THE PREFERRED EMBODIMENTS

The details of one or more embodiments of the presently-disclosed subject matter are set forth in this document. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Unless defined otherwise, all technical and scientific terms used herein have the same meaning as commonly understood by one of ordinary skill in the art to which the presently-disclosed subject matter belongs. Although any methods, devices, and materials similar or equivalent to those described herein can be used in the practice or testing of the presently-disclosed subject matter, representative methods, devices, and materials are now described.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, properties such as reaction conditions, and so forth used in the specification and claims are to be understood as being modified in all instances by the term “about.” Accordingly, unless indicated to the contrary, the numerical parameters set forth in this specification and claims are approximations that can vary depending upon the desired properties sought to be obtained by the presently-disclosed subject matter.

As used herein, the term “about,” when referring to a value or to an amount is meant to encompass variations of ±10% of the most precise digit in the value or amount (e.g., “about 1” refers to 0.9 to 1.1, “about 1.1” refers to 1.09 to 1.11, etc.).

As used herein, ranges can be expressed as from “about” one particular value, and/or to “about” another particular value. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

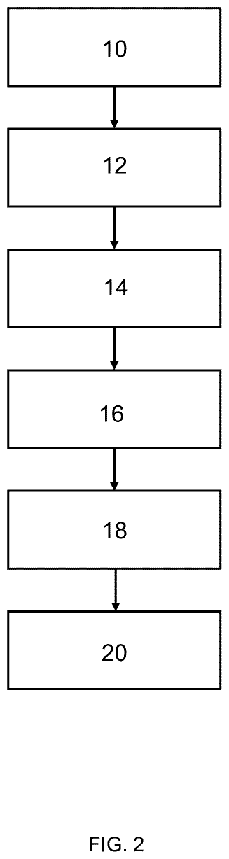

The presently-disclosed subject matter relates to computer-aided classification systems and methods for prediction of cervical vertebral maturation (CVM) stages. The systems and methods are summarized in FIG. 2 as including the following steps: dataset acquisition 10, delineation and ROI extraction 12, cervical vertebrae processing 14, which includes generation of first, second, third, fourth and fifth distance maps (in other embodiments, four or other number of distance maps may be used), markers extraction 16, which includes extraction of contour markers, first-order markers and second-order markers extraction, first stage classification 18, and second stage classification 20. Each of these steps are discussed in further detail below.

With respect to the step of dataset acquisition 10, this invention utilized a dataset of 509 medical images, namely, cephalometric images sourced from the orthodontic clinic's database at the University of Louisville School of Dentistry (ULSD). A panel of three experienced orthodontists from the Department of Orthodontics at ULSD assessed these cephalometric images using the 6-staging method, establishing the ground truth labels. Any disagreements were resolved through discussion, leading to a final staging consensus. The cephalometric images were obtained using a Planmeca ProMax machine (PLANMECA OY, Asentajankatu 6, 00880 Helsinki, FINLAND 2014). The machine's specifications include a power supply of 100-220 V at 50/60 Hz, with a maximum output of 84 KV and total filtration of 2.5 mm Al. The exposure times ranged from 4 to 9.9 s, and the acquired images had dimensions of 24/27×18/30 cm (9/10.6×7/11.8 inches). The 509 cephalometric images were categorized into CVM stages using the 6-staging method, as assessed by the panel of experienced orthodontists. The resultant categorization formed the basis for model training and evaluation, thus readying the model for classification of new cephalometric images.

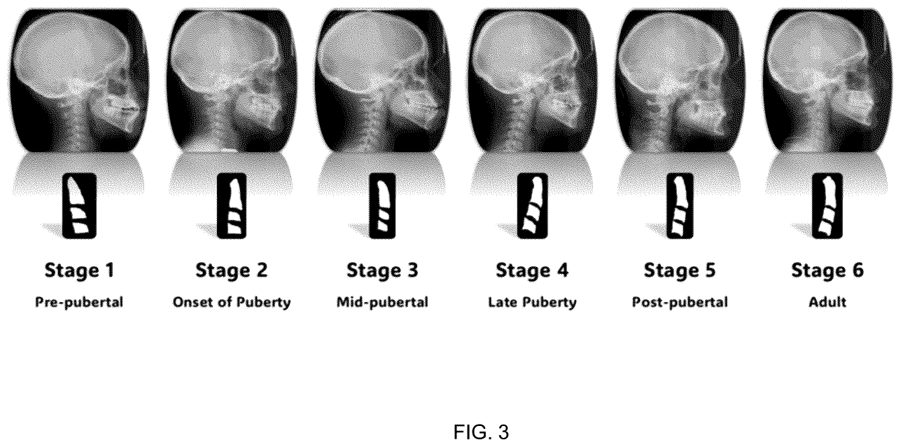

With respect to the step of delineation and ROI extraction 12, manual delineation by experts is a widely used approach in image processing and medical imaging when precision is essential or automated methods are impractical. Trained experts manually outlined the Regions of Interest (ROIs) to accurately identify and trace object boundaries, generating high-quality annotations. Binary masks are then created from the ROIs, acting as filters to retain the pixels within the ROIs while masking out the rest of the image. Extracting the ROIs from the original images involved a simple element-wise multiplication operation, isolating and providing a clean representation of the ROIs. FIG. 3 visualizes samples from the collected and pre-processed cases in each stage where the first row is the original images and the second row represents the masks.

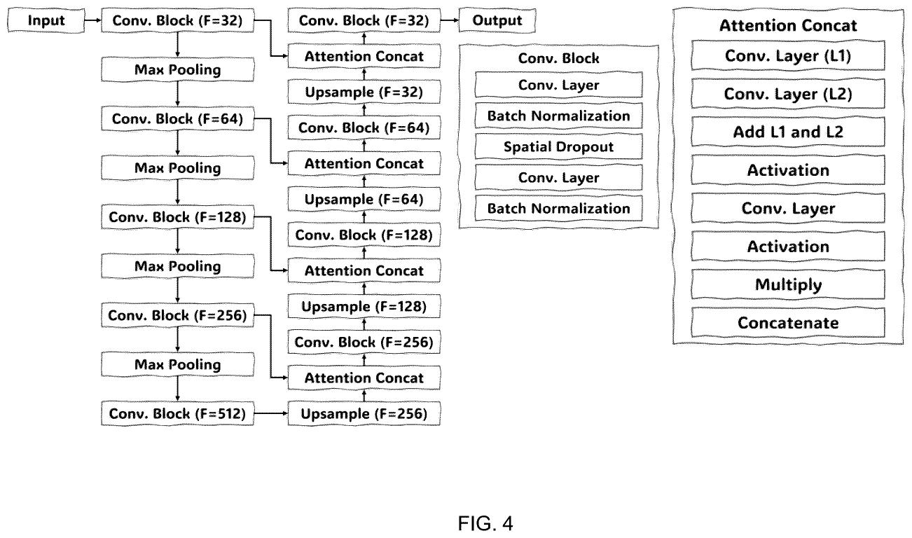

This invention introduces a refined and enhanced U-Net architecture tailored for seamless automatic segmentation. This advanced architecture, as presented in FIG. 4, has been adapted to excel in the precise segmentation of the second, third, and fourth cervical vertebrae from the input scan (i.e., C2, C3, and C4).

The model takes as input images with a shape of (768, 384, 3) and includes a series of convolutional layers, batch normalization layers, spatial dropout layers, and max-pooling layers. The process initiates with a convolutional layer featuring 32 filters, followed by the application of batch normalization and the inclusion of a spatial dropout layer to ensure regularization. This is then followed by another convolutional layer with 32 filters and similar normalization and dropout steps. Subsequent layers continue this pattern, gradually increasing the number of filters while decreasing the spatial dimensions through max-pooling operations. These initial layers serve as feature extractors, capturing different levels of spatial information from the input image.

The architecture then includes a series of transposed convolutional layers (also known as deconvolutional or upsampling layers) for upsampling the feature maps. These layers increase the spatial dimensions while decreasing the number of channels, effectively creating a finer resolution feature map. Skip connections are employed to combine the feature maps from the earlier layers with those from the transposed convolutional layers. These connections aid in the retention of both low- and high-level features during the upsampling process. The final layers of the model involve additional convolutional and normalization steps, followed by a final convolutional layer with a single filter. This last layer outputs a segmentation map with a shape of (768, 384, 1), where each pixel is assigned a value representing its classification as either foreground or background. The model has a total of approximately 7.9 million trainable parameters, making it a relatively deep and complex architecture. The use of batch normalization and spatial dropout helps in improving convergence during training and reducing the risk of overfitting. In some embodiments, the activation functions used throughout the architecture are ReLU.

With respect to the step of cervical vertebrae processing 14, this step involves applying distance maps and marching level-sets to extract parts from medical images. Here, the focus is on extracting Regions of Interest (ROIs) from images of the cervical vertebrae. Distance maps play a role in this process as they allow for the precise delineation and localization of structures based on their proximity to reference points or boundaries. A distance map represents the distance of each pixel in the image to the nearest boundary or reference point. In this case, the reference points could be the boundaries of the cervical vertebrae ROI. By creating five levels of distance maps based on the marching level-sets approach (i.e., 10%, 25%, 50%, 75%, and 100%), the goal is to obtain multiple representations of the iso-contours (i.e., ROIs) with varying levels of granularity.

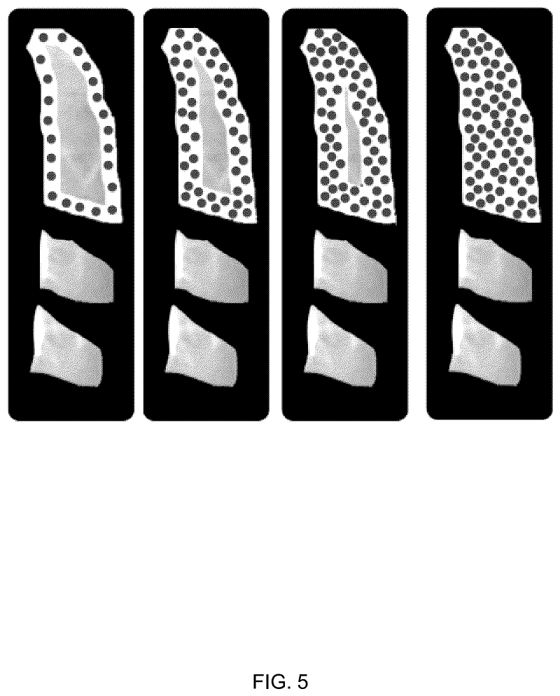

The Marching Level-Sets approach is a powerful and versatile technique in the field of image processing and computer vision primarily used for image segmentation, which is the process of dividing an image into meaningful regions (or objects). This method is particularly valuable when dealing with complex and irregularly shaped objects in digital images. At its core, this approach utilizes the concept of level sets, which are mathematical constructs used to represent evolving curves and shapes. These level sets are essentially functions that define the boundaries of objects within an image. What makes this technique noteworthy is its ability to handle topological changes, such as the merging or splitting of objects, without needing complex parameter adjustments. The basic idea behind Marching Level-Sets is to iteratively evolve the initial level set function towards the desired object boundaries. It does this by employing numerical techniques to minimize an energy functional that guides the evolution process. As the level set function evolves, it “marches” towards the object boundaries, effectively segmenting the image. The steps can be summarized as written in the following points and visualized in FIG. 5:

Level Set Function (Φ): The core of this method is the level set function Φ(x, y), where (x, y) represents the spatial coordinates in the image. This function is defined such that Φ(x, y) is positive inside the object(s) of interest and negative outside. The zero level set (Φ=0) represents the object's boundary. It can be formulated in Eq. (1).

$$Φ ( x , y ) = \{ \begin{matrix}> 0 & Inside the Object ( s ) of Interest . \\ < 0 & Outside the Object ( s ) of Interest . \\ = 0 & Object Boundary\end{matrix} . \qquad ( 1 )$$

Evolution Equation: The evolution of the level set function Φ over time t is described by the following partial differential equation (PDE) presented in Eq. (2) where ∂Φ represents the time evolution of Φ, F is a speed function that controls how Φ evolves, and ∇Φ is the gradient of Φ, representing the direction of the steepest increase in Φ.

$$\frac{\partial Φ}{\partial t} + F \vert ∇ Φ \vert = 0 \qquad ( 2 )$$

Initialization: The level set function Φ is initialized with an initial guess, often a signed distance function. For a binary image, Φ can be initialized as presented in Eq. (3) where I(x, y) is the binary image, taking values 0 or 1.

$$Φ ( x , y ) = 1 - 2 \times I ( x , y ) \qquad ( 3 )$$

Marching Process: The algorithm iteratively updates Φ based on the evolution equation. The zero level set, where Φ=0, represents the evolving contour of the object(s) in the image. As the algorithm progresses, this contour moves towards the object boundaries.

Stopping Criteria: The evolution continues until a stopping criterion is met, which can be based on a predefined number of iterations or the stability of the contour.

Contour Extraction: Once the evolution is complete, the zero level set (Φ=0) represents the final contour(s) of the object(s) in the image. This contour can be extracted for further analysis.

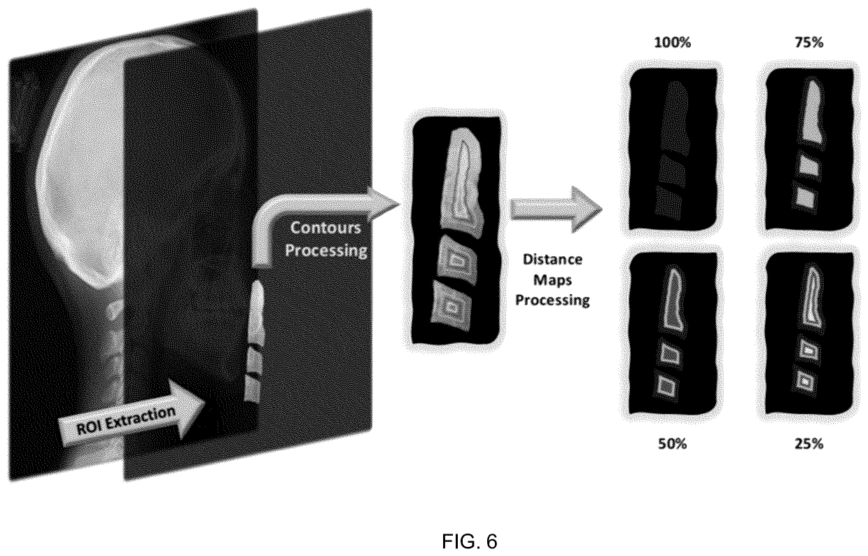

The plurality of levels of distance maps correspond to different distance thresholds. Pixels that fall within the specified threshold distance from the reference points would be assigned a value of 0 or close to 0, indicating they are part of the ROIs. Pixels farther away from the ROIs' boundaries would have higher distance values. By creating multiple distance maps at different levels, the extraction process becomes more flexible, allowing for the generation of segmented ROIs with different levels of detail. Moving from one distance map level to the next, the extracted ROIs become more inclusive, encompassing larger areas of the cervical vertebrae. At the same time, finer details of the ROIs are preserved in the distance maps with smaller thresholds. This multi-level approach provides a comprehensive view of the cervical vertebrae structures, enabling to analyze the region of interest at different scales and make informed decisions based on the extracted markers. FIG. 6 visualizes the ROI extraction and distance maps calculations and pre-processing steps applied on a sample image.

To calculate the distance map, calculate the distance between that pixel and the nearest boundary point for each pixel in the image using Eq. (4) where Distance (x, y) represents the Euclidean distance existing between pixel coordinates (x, y) and the closest boundary point. The equation calculates the minimum distance over all boundary points using the Euclidean distance formula. Then, include pixel at coordinates (x, y) based on a threshold p using Eq. (5), where Distance Map(x, y) is the value assigned to the distance map at pixel coordinates (x, y). If the calculated distance for the pixel is less than or equal to the specified threshold p %, the distance map value is set to that distance. Otherwise, the value is set to 0, indicating exclusion from the distance map.

$$Distance ( x , y ) = {min}_{boundary point} \sqrt{{( x - {x}_{boundary} )}^{2} + {( y - {y}_{boundary} )}^{2}} \qquad ( 4 )$$

$$( 5 )$$

$$Distance Map ( x , y ) = \{ \begin{matrix}Distance ( x , y ) , & if ( Distance ( x , y ) \leq Threshold p \% ) \\ 0 , & Otherwise\end{matrix}$$

With respect to the step of markers extraction 16, contours are fundamental components in image processing and computer vision. They represent the boundaries of objects in an image and play a crucial role in various applications, such as object recognition, shape analysis, and image segmentation. Several contour markers are commonly used to characterize these boundaries. “Perimeter” and “circumference” measure the length of the contour's boundary, with the latter specifically applied to closed curves like circles. “Area” quantifies the number of pixels within the contour, providing insight into the object's spatial extent. “Centroid” calculates the geometric center of the contour, serving as a reference point for analysis. “Aspect ratio” describes the elongation or compression of the object's shape by comparing its width to its height. “Extent” gauges how much of the object's bounding box is occupied, indicating the object's compactness. “Solidity” measures how closely an object resembles a solid shape by comparing its area to its convex hull's area, useful for distinguishing between hollow and solid objects. “Radial distance” provides distance measurements from the centroid to the contour's boundary at various angles, revealing shape symmetry and aiding in shape matching tasks. “Convexity” evaluates the deviation of the contour from being convex, helpful for detecting concavities and convex shapes. In contrast, “compactness” on the other hand, evaluates the roundness of an object by comparing its area to the square of its perimeter. Table 1 displays the equations corresponding to each contour marker.

TABLE 1
Equations for calculating the contour-based markers

| Contour Marker | Equation |
|---|---|
| Area | Area = Σᵢ₌₁ⁿ pixelᵢ. |
| Perimeter | Perimeter = Σᵢ₌₁ⁿ edgeᵢ |
| Centroid (X-coordinate) | ${Centroid}_{x} = \frac{{\sum }_{i = 1}^{n} {pixel}_{j} \times {x}_{i}}{Area}$ |
| Centroid (Y-coordinate) | ${Centroid}_{y} = \frac{{\sum }_{i = 1}^{n} {pixel}_{i} \times {y}_{i}}{Area}$ |
| Radial Distance (from Centroid) | $Radial {Distance}_{i} = \sqrt{{( {x}_{i} - {Centroid}_{x} )}^{2} + {( {y}_{i} - {Centroid}_{y} )}^{2}}$ |
| Aspect Ratio | $Aspect Ratio = \frac{Major Axis Length}{Minor Axis Length}$ |
| Convexity | $Convexity = \frac{Peri m e t e r}{Convex P erimeter}$ |
| Compactness | $Compactness = \frac{{Perimeter}^{2}}{A r e a}$ |
| Extent | $Extent = \frac{A r e a}{Bounding B ox Area}$ |
| Solidity | $Solidity = \frac{Area}{Convex Hull Area}$ |

First-order and second-order markers are useful in texture analysis, a fundamental task in image processing and computer vision. These markers help quantify and describe the texture patterns present in an image, which is valuable for various applications such as image classification, segmentation, and object recognition. First-order markers are simple statistical measures that directly analyze the intensity values of pixels in an image. Common first-order markers include mean, variance, skewness, and kurtosis. The mean calculates the average intensity value of all pixels in the image, providing information about the overall brightness. Variance indicates the degree of spread or dispersion of the intensity values, allowing the uniformity of the texture to be determined. Skewness measures the asymmetry of the energy distribution, while kurtosis refers to the peak or flatness of the distribution. These markers are provide basic information about the image texture but do not consider spatial relationships between pixels. Table 2 displays the equations for calculating the first-order-based markers.

TABLE 2
Equations for calculating the first-order-based markers

| First-Order Marker | Equation |
|---|---|
| Mean | $\frac{1}{N} {\sum }_{i = 1}^{N} {x}_{i}$ |
| Median | Median(x₁, x₂, , x_{N}) |
| Mean Absolute Deviation | $\frac{1}{N} {\sum }_{i = 1}^{N} \vert {x}_{i} - Mean \vert$ |
| Robust Mean Absolute Deviation | $\frac{1}{N} {\sum }_{i = 1}^{N} \vert {x}_{i} - Median \vert$ |
| Median Absolute Deviation | Median(\|x₁ − Median\|, \|x₂) − Median\|, , \|x_{N} − Median\|) |
| Root Mean Square | $\sqrt{\frac{1}{N} {\sum }_{i = 1}^{N} {x}_{i}^{2}}$ |
| Variance | $\frac{1}{N} {\sum }_{i = 1}^{N} {( {x}_{i} - Mean )}^{2}$ |
| Minimum | min(x₁, x₂, , x_{N}) |
| Maximum | max(x₁, x₂, , x_{N}) |
| Skewness | $\frac{\frac{1}{N} {\sum }_{i = 1}^{N} ( {x}_{i} - Mean ) \text{?}}{{( \frac{1}{N} {\sum }_{i = 1}^{N} {( {x}_{i} - Mean )}^{2} )}^{\frac{\text{?}}{2}}}$ |
| Skewness (Alternative) | $\frac{3 \times ( Mean - Median )}{Std}$ |
| Kurtosis | $\frac{\frac{1}{N} {\sum }_{i = 1}^{N} ( {x}_{i} - Mean ) \text{?}}{{( \frac{1}{N} {\sum }_{i = 1}^{N} {( {x}_{i} - Mean )}^{2} )}^{2}}$ |
| Shannon Entropy Cumulative Frequency | $- {\sum }_{i = 1}^{N} p ( {x}_{i} ) {log}_{2} ( p ( {x}_{i} ) )$ $\frac{i}{N} for i = 1 , 2 , , N$ |
| Relative Frequency | $\frac{{Frequency}_{( {x}_{i} )}}{N} for i = 1 , 2 , , N$ |
| Percentiles | Percentiles(p) = Value at index ┌p × N┐ |
| Interquartile Range | Percentiles(0.75) − Percentiles(0.25) |
| Mean X | $\frac{1}{N} {\sum }_{i = 1}^{N} {x}_{i}$ |
| Mean Y | $\frac{1}{N} {\sum }_{i = 1}^{N} {y}_{i}$ |
| Standard Deviation X | $\sqrt{\frac{1}{N} {\sum }_{i = 1}^{N} {( {x}_{i} - Mean X )}^{2}}$ |
| Standard Deviation Y | $\sqrt{\frac{1}{N} {\sum }_{i = 1}^{N} {( {y}_{i} - Mean Y )}^{2}}$ |

$\text{?} \text{indicates text missing or illegible when filed}$

Second-order markers take into account the spatial dependencies between neighboring pixels. Two methods for computing second-order texture markers are the Gray-Level Co-occurrence Matrix (GLCM) and the Gray-Level Run-Length Matrix (GLRLM). GLCM is a texture analysis method that characterizes the co-occurrence of pixel intensity pairs within a specified distance and direction. By computing various statistics from the GLCM, such as contrast, energy, homogeneity, and correlation, texture properties such as the local contrast, regularity, and directionality can be extracted. Eq. (6) presents a general presentation of how to calculate the GLCM value for gray-level pair (i, j) at a specific distance d and angle θ. I(x, y) denotes the pixel intensity at coordinates (x, y) in the image, and Δx, Δy define the spatial relationship. Based on the GLCMd,θ(i, j), the second-order GLCM markers can be calculated as presented in Table 3.

$${GLCM}_{d , θ} ( i , j ) = {\sum }_{x = 1}^{N} {\sum }_{y = 1}^{M} \{ \begin{matrix}1 , & \begin{matrix}if ( I ( x , y ) = i and I ( x + Δ x , y + Δ y ) = j ) \\ at distance d and angle θ\end{matrix} \\ 0 , & Otherwise\end{matrix} \qquad ( 6 )$$

TABLE 3
Equations for calculating the second-order-based GLCM markers

| Second-Order Marker | Equation |
|---|---|
| Energy | $Energy = {\sum }_{i = 1}^{N} {\sum }_{j = 1}^{N} \times {GLCM ( i , j )}^{2}$ |
| Energy SQRT | \sqrt{Energy} |
| Entropy | $- {\sum }_{i = 1}^{N} {\sum }_{j = 1}^{N} \times GLCM ( i , j ) \times log ( GLCM ( i , j ) + ε )$ |
| Contrast | ${\sum }_{i = 1}^{N} {\sum }_{j = 1}^{N} {( i - j )}^{2} \times GLCM ( i , j )$ |
| Correlation | $\frac{{\sum }_{i = 1}^{N} {\sum }_{j = 1}^{N} {( i - {μ}_{x} )}^{} \times ( j - {μ}_{y} ) \times {GLCM}_{( i , j )}}{{σ}_{x} {σ}_{y}}$ |
| Homogeneity | ${\sum }_{i = 1}^{N} {\sum }_{j = 1}^{N} \times \frac{{GLCM}_{( i , j )}}{1 + \vert i - j \vert}$ |
| Angular Second Moment (ASM) | ${\sum }_{i = 1}^{N} {\sum }_{j = 1}^{N} {GLCM ( i , j )}^{2}$ |
| Dissimilarity | ${\sum }_{i = 1}^{N} {\sum }_{j = 1}^{N} \vert i - j \vert \times GLCM ( i , j )$ |
| Inverse Difference (ID) | ${\sum }_{i = 1}^{N} {\sum }_{j = 1}^{N} \frac{{GLCM}_{( i , j )}}{1 + {( i - j )}^{2}}$ |
| Cluster Shade | ${\sum }_{i = 1}^{N} {\sum }_{j = 1}^{N} {( i + j - {μ}_{x} - {μ}_{y} )}^{3} \times GLCM ( i , j )$ |
| Cluster Prominence | ${\sum }_{i = 1}^{N} {\sum }_{j = 1}^{N} {( i + j - {μ}_{x} - {μ}_{y} )}^{4} \times GLCM ( i , j )$ |
| Max. Probability | max(GLCM(i, j)) |

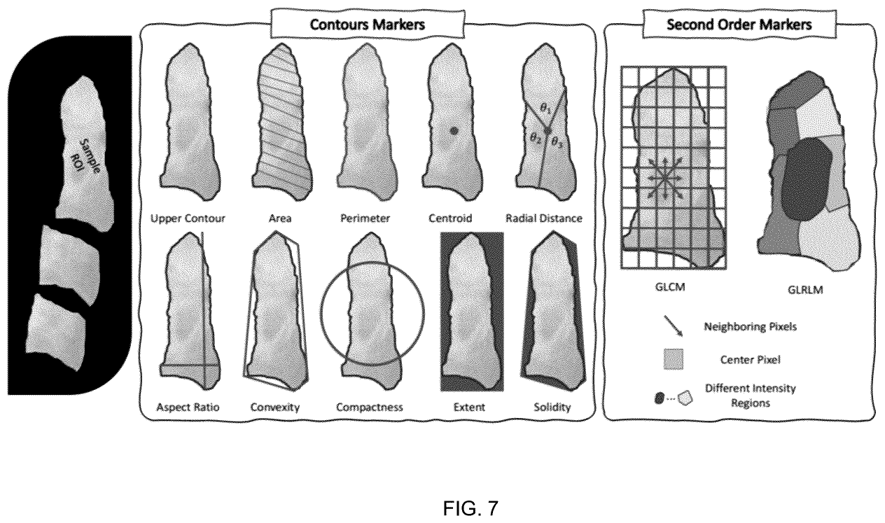

GLRLM focuses on analyzing runs of consecutive pixels with the same intensity value in different directions. The matrix contains run-lengths and the number of occurrences for each run length, providing information about the length and frequency of texture runs. From the GLRLM marks, such as short run emphasis, long run emphasis, and run percentage can be calculated. Eq. (7) presents a general presentation of how to calculate the GLRLM value for run length i and intensity level j. The Run Length(k, l) corresponds to the length of a run of pixels with the same intensity level at coordinates (k, l). Based on the GLRLM(i, j), the second-order GLRLM markers can be calculated as presented in Table 4. FIG. 7 visualizes the contours and second-order markers on a sample image.

$$GLRLM ( i , j ) = {\sum }_{k = 1}^{N} {\sum }_{I = 1}^{M} \{ \begin{matrix}1 , & if ( Run Length ( k , l ) = i \& Intensity Level = j ) \\ 0 , & Otherwise\end{matrix} \qquad ( 7 )$$

TABLE 4
Equations for calculating the second-order-based GLRLM markers

| Second-Order Marker | Equation |
|---|---|
| SRE (Short Run Emphasis) | ${\sum }_{length = 1}^{N} {\sum }_{intensity = 1}^{N} \frac{GLRLM ( length , intensity )}{{length}^{2}}$ |
| LRE (Long Run Emphasis) | Σ^{N}_{length=1}Σ^{N}_{intensity=1} GLRLM(length, intensity) × length² |
| GLN (Gray-Level Nonuniformity) RLN (Run-Length Nonuniformity) | $\frac{\begin{matrix}{\sum }_{length = 1}^{N} {\sum }_{intensity = 1}^{N} {GLRLM ( length , intensity )}^{2} \\ {\sum }_{length = 1}^{N} {\sum }_{intensity = 1}^{N} {GLRLM ( length , intensity )}^{2}\end{matrix}}{{\sum }_{length = 1}^{N} {\sum }_{intensity = 1}^{N} GLRLM ( length , intensity )}$ |
| RP (Run Percentage) | ${\sum }_{intensity = 1}^{N} ( \frac{{\sum }_{length = 1}^{N} GLRLM ( length , intensity )}{length} )$ |
| LGLRE (Low Gray-Level Run Emphasis) | ${\sum }_{length = 1}^{N} {\sum }_{intensity = 1}^{N} \frac{GLRLM ( length , intensity )}{{intensity}^{2}}$ |
| HGLRE (High Gray-Level Run | Σ^{N}_{length=1}Σ^{N}_{intensity=1} GLRLM(length, intensity) × intensity² |
| Emphasis) | |
| SRLGLE (Short Run Low Gray-Level Emphasis) | ${\sum }_{length = 1}^{N} {\sum }_{intensity = 1}^{N} \frac{GLRLM ( length , intensity )}{length \times {intensity}^{2}}$ |
| SRHGLE (Short Run High Gray-Level Emphasis) | ${\sum }_{length = 1}^{N} {\sum }_{intensity = 1}^{N} \frac{GLRLM ( length , intensity )}{{length}^{2} \times intensity}$ |
| LRLGLE (Long Run Low Gray-Level Emphasis) | ${\sum }_{length = 1}^{N} {\sum }_{intensity = 1}^{N} \frac{GLRLM ( length , intensity \vert \times {length}^{2}}{{intensity}^{2}}$ |
| LRHGLE (Long Run High Gray-Level Emphasis) | ${\sum }_{length = 1}^{N} {\sum }_{intensity = 1}^{N} \frac{GLRLM ( length , intensity \vert \times {length}^{2}}{intensity}$ |

In some embodiments, the disclosed systems and methods include means for detection of outliers. Outliers, also known as anomalies, are data points that exhibit significant deviations from the rest of the dataset. The significance of outliers detection lies in its ability to mitigate the impact of inter-observer and intra-observer variability on data analysis and interpretation. Inter-observer variability, stemming from differences in observations among different individuals, and intra-observer variability, reflecting variations in observations made by the same individual over time, can both introduce discrepancies in identifying outliers. By employing robust outlier detection techniques, we can identify and address these discrepancies, ensuring that data points deviating significantly from the majority are appropriately accounted for. This process not only enhances the reliability and reproducibility of research findings but also reduces the influence of subjective interpretations on analysis results.

This system and method may, in some embodiments, utilize one or more outlier detection methods. Let X represent the dataset, and xᵢ denote an individual data point within X. The goal of outlier detection is to identify outliers xᵢ that display substantial deviations from the majority of data points in X. In some embodiments, the outlier detection methods include one or more, two or more, three or more, or all of the following methods: Local Outlier Factor (LOF), Copula-Based Outlier Detection (COPOD), Isolation Forest (IForest), Isolation by Nearest Neighbors (INNE), Kernel Density Estimation (KDE), K-Nearest Neighbors (KNN), Minimum Covariance Determinant (MCD), Clustering-Based Local Outlier Factor (CBLOF), and Extended Connectivity-Based Outlier Detection (ECOD). To detect outliers using these methods, an outliers fraction (α) is set at 15%, indicating the proportion of outliers within the dataset. Each method M generates outlier scores SM (xᵢ) for each data point xᵢ in X. The outlier score SM (xᵢ) quantifies the degree of anomaly exhibited by xᵢ according to method M.

Filtration is then applied using the Wiener filter on these scores, denoted as F_{M} (S_{M} (xᵢ)), where F_{M} represents the filtration function specific to method M. The Wiener filter aims to minimize the mean square error between the original outlier scores and the filtered scores as shown in Eq. (8) where hⱼ represents the filter coefficients, and N denotes the filter length.

$${F}_{M} ( {S}_{M} ( {x}_{i} ) ) = {\sum }_{j = 1}^{N} {h}_{j} \times {S}_{M} ( {x}_{i - j} ) \qquad ( 8 )$$

Post-filtration, the scores are thresholded to obtain a binary array BM (xi), where inliers are represented by 0's and outliers by 1's. Finally, a majority voting scheme is applied to each record to aggregate the binary masks from the different methods. This process ensures robust outlier detection while mitigating potential biases inherent to individual detection techniques.

Feature selection techniques are preferably used to enhance the efficiency and interpretability of our models. One aspect of feature selection is identifying collinear features, which are highly correlated with each other. Collinear features can introduce redundancy into the model, leading to overfitting and decreased generalization performance. To address this issue, a method was employed to find collinear features based on the correlation coefficient between features. The correlation coefficient measures the strength and direction of a linear relationship between two variables, ranging from −1 to 1. A correlation coefficient close to 1 indicates a strong positive linear relationship, while a coefficient close to −1 indicates a strong negative linear relationship. A coefficient close to 0 suggests little to no linear relationship.

Mathematically, the correlation coefficient (ρ) between two features X and Y is calculated as presented in Eq. (9) where cov(X, Y) is the covariance between X and Y, ox and oy are the standard deviations of X and Y, respectively, Xᵢ and Yᵢ are the individual values of the random variables X and Y, μ_{X} and μ_{Y} are the means of X and Y, respectively, n is the number of data points.

$${ρ}_{X , Y} = \frac{cov ( X , Y )}{{σ}_{X} \times {σ}_{Y}} = \frac{\frac{1}{n} \times {\sum }_{i = 1}^{n} ( {X}_{i} - {μ}_{X} ) \times ( {Y}_{i} - {μ}_{Y} )}{{σ}_{X} \times {σ}_{Y}} \qquad ( 9 )$$

For each pair of features, we set a correlation threshold that is set to 90% in the current study. If the correlation coefficient between two features exceeds this threshold, one of the pair is identified for removal. This selection process ensures that only one of the highly correlated features is retained in the model, reducing redundancy and improving model interpretability without sacrificing predictive performance. By effectively identifying and removing collinear features based on the correlation coefficient, the feature space is streamlined, leading to more robust and efficient models.

During the classification phase, the preprocessed markers undergo a multi-level classification process involving multiple classifiers including, in some embodiments, LightGBM (LGBM), eXtreme Gradient Boosting (XGB), and Histogram Gradient Boosting (HGB). With respect to the step of first stage classification 18, the initial three classes (i.e., CS1, CS2 and CS 3) are amalgamated into a class denoted as X, while the subsequent classes (i.e., CS4, CS5 and CS6) are amalgamated another class denoted as Y. The first stage of classification focuses on differentiating between classes X and Y. The ultimate decision is reached through a weighted majority voting mechanism. This process is duplicated in parallel for the subsequent stage.

With respect to the step of second stage classification 20, a multi-level classification procedure operates to either distinguish among CS1, CS2 and CS3, if class X was designated in the first stage 18, or distinguish among CS4, CS5 and CS6, if class Y was designated in the first stage 18. The final prediction is once again determined by employing a weighted majority voting strategy.

To illustrate, consider an input image subjected to marker pre-processing and markers extraction. Subsequently, the image enters the first classification stage. Based on the outcome, the image is directed either to the left (in the case of classification as X) or to the right (in the case of classification as Y). In the subsequent stage, the decision-making process discerns whether the image belongs to stages 1 through 6.

The described multi-stage multi-level classification process can be represented as a mathematical model as follows. Let I be the set of input images, M represent the marker pre-processing and extraction process, C1 and C2 be the sets of classes representing the outcomes X and Y of the first classification stage, respectively, and D be the decision-making process that directs images to stages 1 through 6.

The high-level mathematical representation of the process is provided in Eq. (10) where the function F maps input images to their extracted markers using marker pre-processing and markers extraction. P₁ is a probabilistic classifier that assigns a probability distribution over classes C₁ and C₂ based on the extracted markers. D₁ is a decision-making process that directs the image either to class C₁ or C₂ based on the outcome of the first classification stage. For each stage i, there is a probabilistic classifier PS_{tage} that assigns a probability distribution over stages S₁ through S₆ based on the extracted markers. D_{Stage} is a decision-making process that assigns the image to one of the stages based on the outcomes of the subsequent classification stages. Putting it all together, the multi-stage multi-level classification process can be represented as a composition of these functions as presented in the last line of this Eq. (10).

$$F : I \to F ( I ) \qquad ( 10 )$$

$${P}_{1} : F ( I ) \to P ( {C}_{1} , {C}_{2} )$$

$$D 1 : P ( C 1 , C 2 ) \to \{ Left , Right \}$$

$${P}_{Stage} : F ( I ) \to P ( {S}_{1} , {S}_{2} , … , {S}_{6} )$$

$${D}_{Stage} : P ( {S}_{1} , {S}_{2} , … , {S}_{6} ) \to \{ Stage 1 , … , Stage 6 \}$$

$$Overall Model : {D}_{stage} ( {P}_{Stage} ( F ( {D}_{1} ( F ( I ) ) ) ) ) )$$

The utilized classifiers include, in some embodiments, Support Vector Machine (SVM), K-Nearest Neighbors (KNN), Random Forest (RF), Decision Trees (DT), LGBM, XGB, HGB, Multi-Layer Perceptron (MLP), Adaptive Boosting (AdaBoost), and Logistic Regression (LR). DTs are interpretable models that recursively partition the feature space into regions. However, they may suffer from overfitting, thus, ensemble methods like RF were investigated. RF constructs multiple decision trees and aggregates their predictions, leading to improved generalization performance and reduced overfitting. The RF is then compared with other ensemble techniques (e.g., LGBM, XGB, and HGB). These gradient boosting methods have been shown to be highly effective for complex datasets. On the other hand, instance-based classifiers like KNN classify new instances based on the majority class among their k-nearest neighbors. Another popular classifier that is investigated is the SVM, which aims to find the optimal hyperplane that best separates the classes in the feature space. The MLP consists of multiple layers of interconnected nodes. Additionally, AdaBoost, a boosting algorithm that iteratively trains weak learners in a weighted manner, giving more importance to the misclassified samples is also included. Lastly, LR, a simple yet effective linear classifier used as a baseline for comparison against more complex models is applied. LR models the probability of an instance belonging to a certain class.

As mentioned, the two stages use the weighted majority voting (WMV), which is presented in Eq. (11), where N refers to the number of classifiers, i indexes the class labels cᵢ being considered, j indexes the classifiers, wⱼ denotes the weight assigned to the jth classifier which is the weighted sum metric (WSM) value, yᵢⱼ is the prediction of the jth classifier for class cᵢ, the function I(⋅) denotes the indicator function, which yields a value of 1 when the condition is met and 0 otherwise. In short, WMV is a decision-making approach that holds significance in aggregating the outputs of multiple classifiers or models. In WMV, each classifier's prediction is accorded a certain weight based on its individual performance or reliability. These weights reflect the WSM of the respective classifiers in their classifications.

$$WMV = {}_{i}^{argmax} {\sum }_{j = i}^{N} {w}_{j} \times I ( {y}_{ij} = {c}_{i} ) \qquad ( 11 )$$

Performance metrics play an important role in evaluating the effectiveness of classification models. Here, classification selection was guided by the use of WSM for comparative analysis. WSM is characterized by key metrics: accuracy, precision, specificity, sensitivity, F1 score, balanced accuracy (BAC), and receiver operating characteristic (ROC) curve analysis The adoption of WSM ensures a continuous analysis further and balances the classifier performance over multiple dimensions. The WSM equation is presented in Eq. (12).

$$WSM = \frac{1}{7} \times ( Accuracy + Sensitivity + Specificity + Precision + F 1 + ROC + BAC ) \qquad ( 12 )$$

Accuracy is an important determinant of the classification. Sensitivity (i.e., recall) refers to the proportion of true predictions among the actual positive instances. In contrast, Specificity refers to the proportion of negative prediction accuracy that applies to the total number of truly negative instances. It complements sensitivity by offering insights into the classifier's ability to correctly identify negative instances. Precision is a measurement that highlights the accuracy of positive predictions compared to the overall predicted positive instances. The F1 score is a balanced metric that considers both precision and sensitivity, providing a harmonic mean of the two measures. It is especially useful in imbalanced datasets, where neither precision nor sensitivity alone would be sufficient to evaluate the classifier's performance. The BAC is the arithmetic mean of sensitivity and specificity offering a balanced justification of the classifier's performance across both positive and negative instances. The ROC curve is a graphical representation of the classifier's performance at various thresholds, plotting the true positive fraction (i.e., sensitivity) on the y-axis against the false positive fraction (i.e., 1−specificity) on the x-axis.

With the adoption of a two-stage classifier, attention must be directed towards the potential for error propagation from the initial to the final stage. Addressing how uncertainties or borderline cases are managed in each phase is relevant to maintaining the integrity and accuracy of the overall system. One strategy to mitigate error propagation involves filtering out wrongly predicted instances before advancing to the subsequent phase. For example, if the first stage of the classifier classifies a CVM as belonging to the first group (i.e., stages CS1, CS2 or CS3) then only classification results of CS1, CS2 or CS3 from the second stage of the classifier would be relevant and any predictions of CS4, CS5 or CS6 from the second stage would be discarded. For another example, the system may include a confidence threshold for each classification decision in the first stage falling below the confidence threshold can be excluded from advancing to the second stage or flagged for further review. By implementing such measures, only the most confidently classified cases contribute to the final decision, thereby bolstering the reliability and robustness of the classification system.

The proposed approach, as mentioned, involves working with five levels of distance maps (i.e., 10%, 25%, 50%, 75%, and 100%). In other embodiments, three, four, six, or greater numbers of distance maps may be used. These levels are processed individually, and a weighted majority voting is utilized between them. The approach consists of two cascaded levels, with the first level dividing the records into two groups, and the second level operating on each of these groups. The reported results show the performance metrics obtained by applying weighted majority voting on five different distance maps (P1 to P5) using a testing subset. The classifiers used were DT, RF, GB, HGB, LGBM, XGB, SVM, AB, LR, and KNN. The Local Outlier Factor (LOF), Copula-Based Outlier Detection (COPOD), Isolation Forest (IForest), Isolation by Nearest Neighbors (INNE), Kernel Density Estimation (KDE), K-Nearest Neighbors (KNN), Minimum Covariance Determinant (MCD), Clustering-Based Local Outlier Factor (CBLOF), and Extended Connectivity-Based Outlier Detection (ECOD) were utilized for features detection and The Wiener filtration method was used to filter and binarize outliers and inliers. The initial length of the features vector is 267 and 10% of the features are dropped. Each individual experiment is run 10 times, and the mean values are determined. The train-to-test split is set to 70%: 30% for training and testing respectively. The correlation threshold is set to 90% to find the collinear features.

For the first stage, Table 5 provides a comprehensive overview of the performance metrics for various classifiers in the first stage, as well as their combined performance on the entire dataset. The metrics evaluated include Accuracy, Sensitivity, Specificity, Precision, F1 score, ROC score, BAC, AUC (Area Under Curve), and the mean of all metrics. The classifiers are ranked based on their performance, with the best-performing classifier for each metric highlighted in bold. Moreover, the best of the different combinations are reported in the lower section of the table.

TABLE 5
First stage performance summary. The upper section of the table displays individual classifier performance metrics derived from majority voting
on five distance maps for each combined classifier and scalar. The lower section displays combinations of classifiers. Rows displayed in bold
text indicated the highest-performing metrics. The upward arrows adjacent to column headers indicate that higher numerical values are preferred.

| | | Accuracy | Precision | Recall | Specificity | F1 | IoU | BAC | MCC | Youden | Yule | AUC | Mean | |
|---|---|---|---|---|---|---|---|---|---|---|---|---|---|---|
| Classifier | Scaler | ↑ | ↑ | ↑ | ↑ | ↑ | ↑ | ↑ | ↑ | ↑ | ↑ | ↑ | ↑ | Order |
| GB | None | 96.27 | 96.90 | 95.79 | 96.77 | 96.34 | 92.94 | 96.28 | 92.54 | 92.56 | 99.71 | 96.28 | 95.67 | 1 |
| LGBM | MaxAbs | 96.27 | 96.90 | 95.79 | 96.77 | 96.34 | 92.94 | 96.28 | 92.54 | 92.56 | 99.71 | 96.28 | 95.67 | 3 |
| AB | None | 96.07 | 97.25 | 95.02 | 97.18 | 96.12 | 92.54 | 96.10 | 92.17 | 92.20 | 99.70 | 96.10 | 95.49 | 3 |
| RF | None | 96.07 | 96.89 | 95.40 | 96.77 | 96.14 | 92.57 | 96.09 | 92.15 | 92.18 | 99.68 | 96.09 | 95.46 | 4 |
| XGB | None | 96.07 | 96.89 | 95.40 | 96.77 | 96.14 | 92.57 | 96.09 | 32.15 | 92.18 | 99.68 | 96.09 | 95.46 | 5 |
| DT | Robust | 95.87 | 97.24 | 94.64 | 97.18 | 95.92 | 92.16 | 95.91 | 91.78 | 91.81 | 99.67 | 95.91 | 95.28 | 6 |
| HGB | MaxAbs | 95.87 | 96.51 | 95.40 | 96.37 | 95.95 | 92.22 | 95.89 | 91.75 | 91.77 | 99.64 | 95.89 | 95.21 | 7 |
| ET | None | 95.68 | 96.14 | 95.40 | 95.97 | 95.77 | 91.88 | 95.69 | 91.35 | 91.37 | 99.60 | 95.69 | 94.96 | 8 |
| MLP | STD | 95.09 | 96.09 | 94.25 | 95.97 | 98.16 | 90.77 | 95.11 | 90.19 | 90.22 | 99.49 | 95.11 | 94.31 | 9 |
| SVC | STD | 91.16 | 92.52 | 90.04 | 92.34 | 91.26 | 83.93 | 91.19 | 82.35 | 82.38 | 98.18 | 91.19 | 89.68 | 10 |
| LR | Robust | 90.57 | 92.77 | 88.51 | 92.74 | 90.59 | 82.80 | 90.62 | 81.24 | 81.25 | 97.99 | 90.62 | 89.06 | 11 |
| KNN | MinMax | 87.62 | 88.37 | 87.36 | 87.90 | 87.86 | 78.35 | 87.63 | 75.24 | 75.26 | 96.09 | 87.63 | 85.39 | 13 |

| | Accuracy | Precision | Recall | Specificity | F1 | IoU | BAC | MCC | Youden | Yule | AUC | Mean | |
|---|---|---|---|---|---|---|---|---|---|---|---|---|---|
| Combination | ↑ | ↑ | ↑ | ↑ | ↑ | ↑ | ↑ | ↑ | ↑ | ↑ | ↑ | ↑ | Order |
| GB, HGB | 96.27 | 96.90 | 95.79 | 96.77 | 96.34 | 92.94 | 96.28 | 92.54 | 93.56 | 99.71 | 96.28 | 95.61 | Top-2 |
| AB, GB, LR | 96.66 | 97.66 | 95.79 | 97.58 | 96.71 | 93.63 | [symbol] | 93.34 | 93.37 | 99.78 | 96.68 | 95.12 | Top-3 |
| AB, GB, LGBM, LR | 96.86 | 97.67 | 96.17 | 97.58 | 96.91 | 94.01 | 96.87 | 93.72 | 93.75 | 99.80 | 96.87 | 96. [symbol] | Top-4 |
| AB, GB, KNN, LGBM, LR | 96.66 | 97.66 | 95.79 | 97.58 | 96.71 | 93.63 | 96.68 | 93.34 | 93.37 | 99.78 | 96.68 | 96.12 | Top-5 |
| AB, DT, GB, | 96.66 | 97.66 | 95.79 | 97.58 | 96.71 | 93.63 | 96.68 | 93.34 | 93.37 | 99.78 | 96.68 | 96.12 | Top-6 |
| LGBM, LR, MLP | | | | | | | | | | | | | |
| AB, ET, GB, KNN, LR, | 96.66 | 97.66 | 95.79 | 97.58 | 96.71 | 93.63 | 96.68 | 93.38 | 93.37 | 99.78 | 96.68 | 96.12 | Top-7 |
| MLP, XGB | | | | | | | | | | | | | |
| AB, ET, GB, KNN, LR, | 96.66 | 97.66 | 95.79 | 97.58 | 96.71 | 93.63 | 96.68 | 93.34 | 93.37 | 99.78 | 96.68 | 96.12 | Top-8 |
| MLP, RE, KGB | | | | | | | | | | | | | |
| AB, DT, GB, KNN, LR, | 96.66 | 97.66 | 95.79 | 97.58 | 96.71 | 93.63 | 95.68 | 33.34 | 93.37 | 99.78 | 96.68 | 96.12 | Top-9 |
| [symbol] , RF, SVC, XGB | | | | | | | | | | | | | |
| AB, ET, GB, | 96.66 | 97.66 | 95.79 | 97.58 | 96.71 | 93.63 | 96.68 | 93.34 | 93.37 | 99.78 | 96.68 | 96.12 | Top-10 |
| HGB, KNN, | | | | | | | | | | | | | |
| LR, [symbol] , RF, | | | | | | | | | | | | | |
| SVG, XGB | | | | | | | | | | | | | |
| AB, DT, ET, GB, | 96.46 | 97.28 | 95.79 | 97.18 | 96.53 | 93.28 | 96.48 | 92.94 | 92.96 | 99.74 | 96.48 | 95.86 | Top-11 |
| HGB, KNN, LGBM, | | | | | | | | | | | | | |
| LR, RF, SVC, XGB | | | | | | | | | | | | | |
| AB, DT, ET, | 96.27 | 96.90 | 95.79 | 96.77 | 96.34 | 92.94 | [symbol] | 92.54 | 92.56 | 99.71 | 96.28 | 95.61 | All |
| GB, HGB, KNN, | | | | | | | | | | | | | |
| LGBM, LR, MLP, | | | | | | | | | | | | | |
| RF, SVC, KGB | | | | | | | | | | | | | |

[symbol]

indicates data missing or illegible when filed

Among the individual classifiers, the GB stood out as the top performer across various metrics. Utilizing no scaler, GB demonstrated remarkable accuracy, precision, recall, specificity, F1 score, IoU, BAC, MCC, Youden index, AUC, and Yule's Q, reflecting its robustness and reliability in classification tasks. With a mean score of 95.67%, GB secured the top position, underscoring its effectiveness in the classification framework.

Expanding the analysis to combinations of classifiers, combining GB with other high-performing classifiers further enhanced the classification performance. Specifically, the combination of AB, GB, LGBM, and LR emerged as the top performer among the top four combinations. With a mean score of 96.33%, this ensemble showcased superior accuracy, precision, specificity, and other metrics, surpassing individual classifiers and lesser combinations. This underscores the synergistic effect of combining complementary classifiers, utilizing the strengths of each component to achieve superior classification outcomes.

For the second stage, Table 6 presents a comprehensive overview of the performance metrics for various classifiers in the second stage for the upward portion (i.e., stages 1 to 3), along with their combined performance on the entire dataset. The metrics evaluated include Accuracy, Sensitivity, Specificity, Precision, F1 score, ROC score, BAC, AUC, and the mean of all metrics. The classifiers are ranked based on their performance, and the best-performing classifier for each metric is highlighted in bold.

TABLE 6
Second stage (upper portion) performance summary. The upper section of the table displays individual classifier
performance metrics derived from majority voting on five distance maps for each combined classifier and scalar.
The lower section displays combinations of classifiers. Rows displayed in bold text indicated the highest-performing
metrics. The upward arrows adjacent to column headers indicate that higher numerical values are preferred.

| | | Accuracy | Precision | Recall | Specificity | F1 | IoU | BAC | MCC | Youden | Yule | AUC | Mean | |
|---|---|---|---|---|---|---|---|---|---|---|---|---|---|---|
| Classifier | Scaler | ↑ | ↑ | ↑ | ↑ | ↑ | ↑ | ↑ | ↑ | ↑ | ↑ | ↑ | ↑ | Order |
| DT | Robust | 91.00 | 86.35 | 86.21 | 93.11 | 86.19 | 76.00 | 89.66 | 79.46 | 79.32 | 97.73 | 89.19 | 86.75 | 1 |
| MLP | STD | 90.41 | 85.84 | 85.44 | 92.48 | 85.26 | 74.57 | 88.96 | 78.43 | 77.92 | 97.89 | 88.48 | 85.97 | 2 |
| XGB | STD | 90.32 | 85.51 | 85.44 | 92.13 | 85.26 | 74.50 | 88.78 | 78.04 | 77.57 | 97.56 | 88.31 | 85.77 | 3 |
| LGBM | STD | 90.18 | 85.82 | 85.44 | 91.95 | 85.28 | 74.43 | 88.70 | 78.07 | 77.39 | 97.74 | 88.38 | 85.76 | 4 |
| HGB | None | 89.95 | 85.74 | 85.06 | 91.65 | 84.89 | 73.87 | 88.35 | 77.64 | 76.71 | 97.78 | 87.92 | 85.41 | 5 |
| GB | MinMax | 89.80 | 85.02 | 84.67 | 91.60 | 84.41 | 73.25 | [symbol] | 77.03 | 76.28 | 97.54 | 87.60 | 85.03 | 6 |
| ET | None | 89.65 | 84.97 | 84.67 | 91.47 | 84.51 | 73.27 | 88.07 | 76.81 | 76.15 | 97.30 | 87.74 | 84.97 | 7 |
| RF | MaxAbs | 89.56 | 85.46 | 84.67 | 91.18 | 84.50 | 73.22 | 87.93 | 76.91 | 75.86 | 97.52 | 87.61 | 84.95 | 8 |
| AB | None | 87.41 | 81.45 | 81.23 | 89.95 | 81.07 | 68.32 | 85.59 | 71.66 | 71.17 | 95.62 | 85.21 | 81.70 | 9 |
| LR | STD | 79.03 | 70.18 | 68.97 | 82.34 | 67.64 | 51.77 | 75.65 | 52.99 | 51.31 | 86.60 | 74.80 | 69.21 | 10 |
| SVC | STD | 76.84 | 69.65 | 65.52 | 79.57 | 61.03 | 46.39 | 72.55 | 47.77 | 45.09 | 86.14 | 70.98 | 65.59 | 11 |
| KNN | MinMax | 76.17 | 66.58 | 64.75 | 80.62 | 64.06 | 47.50 | 72.69 | 47.31 | 45.37 | 81.77 | 72.17 | 65.36 | 12 |

| | Accuracy | Precision | Recall | Specificity | F1 | IoU | BAC | MCC | Youden | Yule | AUC | Mean | |
|---|---|---|---|---|---|---|---|---|---|---|---|---|---|
| Combination | ↑ | ↑ | ↑ | ↑ | ↑ | ↑ | ↑ | ↑ | ↑ | ↑ | ↑ | ↑ | Order |
| DT, ET | 91.00 | 86.35 | 86.21 | 93.11 | 86.19 | 76.00 | 89.66 | 79.45 | 79.32 | 97.73 | 89.19 | 86.50 | Top-2 |
| DT, LR, RF | 91.72 | 88.10 | 87.74 | 93.12 | 87.65 | 78.06 | 98.43 | 81.51 | 80.86 | 98.45 | 90.13 | 87.76 | Top-3 |
| DT, KNN, LR, XGB | 92.63 | 89.17 | 88.89 | 93.80 | 88.73 | 79.88 | 91.34 | 83.35 | 82.68 | 98.83 | 90.86 | 88.93 | Top-4 |
| DT, HGB, LGBM, SVC, | 91.57 | 87.65 | 87.36 | 92.99 | 87.18 | 77.42 | 90.17 | 81.02 | 80.34 | 98.40 | 89.71 | 87.41 | Top-5 |
| XGB | | | | | | | | | | | | | |
| DT, ET, HGB, KNN, | 91.85 | 87.95 | 87.74 | 93.20 | 87.54 | 78.01 | 90.47 | 81.58 | 80.94 | 98.47 | 89.98 | 87.77 | Top-6 |
| MLP, XGB | | | | | | | | | | | | | |
| DT, KNN, LGBM, LR, | 91.56 | 87.72 | 87.36 | 92.87 | 87.13 | 77.36 | 90.11 | 81.02 | 80.23 | 98.45 | 89.61 | [symbol] | Top-7 |
| MLP, SVC, KGB | | | | | | | | | | | | | |
| DT, HGB, KNN, LGBM, | 91.80 | 88.23 | 87.74 | 93.00 | 87.51 | 77.95 | 90.37 | 81.64 | 80.74 | 98.63 | 89.87 | 87.76 | Top 8 |
| LR, MLP, SVC, XGB | | | | | | | | | | | | | |
| AB, DT, ET, HGB, KNN, | 91.51 | 87.68 | 87.36 | 92.86 | 87.18 | 77.39 | 90.11 | 80.94 | 80.22 | 98.35 | 89.69 | 87.36 | Top-9 |
| LR, MLP, RF, XGB | | | | | | | | | | | | | |
| AB, DT, ET, HGB, KNN, | | | | | | | | | | | | | |
| LGBM, LR, MLP, SVC, | 91.28 | 87.43 | 86.97 | 92.66 | 86.77 | 76.77 | 89.82 | 80.46 | 79.63 | 98.36 | 89.34 | 87.02 | Top-10 |
| XGB | | | | | | | | | | | | | |
| AB, DT, ET, MGB, KNN, | 91.27 | 87.33 | 86.97 | 92.63 | 86.76 | 76.77 | 89.80 | 80.38 | 79.60 | 98.25 | 89.33 | 86.98 | Top-11 |
| LGBM, LR, MLP, RF, | | | | | | | | | | | | | |
| SVC, XGB | | | | | | | | | | | | | |
| AB, DT, ET, GB, HGB, | | | | | | | | | | | | | |
| KNN, LGBM, LR, MLP, | 91.28 | 87.43 | 86.97 | 92.66 | 86.77 | 76.77 | 89.82 | 80.46 | 79.63 | 98.36 | 89.34 | 87.02 | All |
| RF, SVG, XGB | | | | | | | | | | | | | |

[symbol]

indicates data missing or illegible when filed

Among the individual classifiers, DT was the top performer across various metrics. Utilizing the robust scaler, DT showcased exceptional accuracy, precision, recall, specificity, F1 score, IoU, BAC, MCC, Youden index, and Yule's Q. With a mean score of 86.75, MLP secured the leading position, highlighting its effectiveness in the upper-level classification task.

Expanding the analysis to combinations of classifiers, combining MLP with other high-performing classifiers led to further enhancements in classification performance. Specifically, the combination of DT, KNN, LR, and XGB emerged as the top performer among the top four combinations. With a mean score of 88.93, this ensemble exhibited superior accuracy, precision, specificity, and other metrics, surpassing both individual classifiers and lesser combinations. This underscores the synergistic effect achieved by combining complementary classifiers, utilizing the strengths of each component to attain superior classification outcomes.

Table 7 presents a comprehensive overview of the performance metrics for various classifiers in the second stage for the downward portion (stages 4 to 6), along with their combined performance on the entire dataset. The metrics evaluated encompass Accuracy, Sensitivity, Specificity, Precision, F1 score, ROC score, BAC and the Mean of all metrics. The classifiers are ranked based on their performance, with the best-performing classifier for each metric highlighted in bold. Among the individual classifiers, GB demonstrated notable performance, particularly when paired with the MinMax scaler. It exhibited superior accuracy, precision, recall, specificity, F1 score, IoU, BAC, MCC, Youden index, AUC, and Yule's Q, showcasing its reliability in classification tasks with a mean score of 85.73.

TABLE 7
Second stage (lower portion) performance summary. The upper section of the table displays individual classifier
performance metrics derived from majority voting on five distance maps for each combined classifier and scalar.
The lower section displays combinations of classifiers. Rows displayed in bold text indicated the highest-performing
metrics. The upward arrows adjacent to column headers indicate that higher numerical values are preferred.

| | | Accuracy | Precision | Recall | Specificity | F1 | IoU | BAC | MCC | Youden | Yule | AUC | Mean | |
|---|---|---|---|---|---|---|---|---|---|---|---|---|---|---|
| Classifier | Scaler | ↑ | ↑ | ↑ | ↑ | ↑ | ↑ | ↑ | ↑ | ↑ | ↑ | ↑ | ↑ | Order |
| HGB | MaxAbs | 89.68 | 85.97 | 85.89 | 91.25 | 85.90 | 75.30 | 88.57 | 77.44 | 77.14 | 96.96 | 88.91 | 85.73 | 1 |
| RF | MinMax | 89.55 | 86.20 | 85.48 | 90.34 | 85.37 | 74.51 | 87.91 | 77.10 | 75.83 | 97.27 | 87.45 | 85.18 | 2 |
| LGBM | MinMax | 89.28 | 85.39 | 85.08 | 90.49 | 85.04 | 74.02 | 87.79 | 76.38 | 75.57 | 96.89 | 87.59 | 84.86 | 3 |
| MLP | Robust | 89.19 | 84.82 | 84.68 | 91.07 | 84.71 | 73.61 | 87.87 | 75.93 | 75.75 | 96.56 | 87.82 | 84.73 | 4 |
| XGB | None | 89.06 | 84.74 | 84.68 | 90.72 | 84.62 | 73.38 | 87.70 | 75.77 | 75.40 | 96.67 | 87.61 | 84.58 | 5 |
| ET | None | 88.73 | 85.35 | 84.68 | 89.83 | 84.67 | 73.42 | 87.25 | 75.59 | 74.50 | 96.56 | 87.27 | 84.35 | 6 |
| GB | MaxAbs | 88.58 | 84.51 | 84.27 | 90.11 | 84.25 | 72.80 | 87.19 | 74.98 | 74.38 | 96.36 | 87.26 | 84.06 | 7 |
| DT | MinMax | 87.83 | 83.50 | 83.47 | [symbol] | 83.47 | 71.65 | 86.66 | 73.48 | 73.33 | 95.57 | 87.29 | 83.28 | 8 |
| AB | STD | 82.67 | 81.87 | 76.61 | 83.58 | 76.39 | 61.82 | 80.10 | 65.02 | 60.19 | 95.76 | 80.12 | 76.74 | 9 |
| LR | Robust | 83.12 | 77.08 | 76.21 | [symbol] | 76.37 | 62.18 | [symbol] | 62.70 | 61.86 | 90.20 | [symbol] | 76.10 | 10 |
| SVC | Robust | 78.99 | 77.13 | 69.35 | 78.64 | 63.51 | 51.34 | 74.00 | 51.24 | 48.00 | 91.32 | 70.32 | 68.53 | 11 |
| KNN | Robust | 74.38 | 68.29 | 64.31 | 75.77 | 61.26 | 45.59 | 69.94 | 42.83 | 39.88 | 78.93 | 68.11 | 62.64 | 12 |

| | Accuracy | Precision | Recall | Specificity | F1 | IoU | BAC | MCC | Youden | Yule | AUC | Mean | |
|---|---|---|---|---|---|---|---|---|---|---|---|---|---|
| Combination | ↑ | ↑ | ↑ | ↑ | ↑ | ↑ | ↑ | ↑ | ↑ | ↑ | ↑ | ↑ | Order |
| HGB, KNN | 89.68 | 85.97 | 85.89 | 91.25 | 85.90 | 75.30 | [symbol] | 77.44 | 77.14 | 96.96 | [symbol] | 85.41 | Top-2 |
| AB, LGBM, MLP | 90.41 | 87.30 | 86.69 | 91.34 | 86.68 | 76.52 | 89.01 | 79.10 | 78.03 | 97.86 | [symbol] | 86.29 | Top-3 |
| HGB, KNN, LR, RF | 90.57 | 87.39 | 87.10 | 91.68 | 87.12 | 77.19 | 89.39 | 79.44 | 78.77 | 97.62 | 89.50 | 86.63 | Top-4 |
| AB, HGB, LGBM, MLP, | 90.66 | 87.70 | 87.10 | 91.46 | 87.08 | 77.14 | 89.28 | 79.67 | 78.56 | 97.96 | 89.08 | 86.66 | Top-5 |
| SVC | | | | | | | | | | | | | |
| AB, DT, HGB, MLP, | 90.98 | 88.54 | 87.50 | 91.50 | 87.46 | 77.74 | 89.50 | 80.58 | 79.00 | 98.51 | 89.12 | 87.13 | Top-6 |
| SVC, XGB | | | | | | | | | | | | | |
| AB, HGB, LGBM, LR, | 90.41 | 87.18 | 86.69 | 91.36 | 86.68 | 76.52 | 89.03 | 79.02 | 78.06 | 97.74 | 88.83 | 86.27 | Top-7 |
| MLP, RF, SVC | | | | | | | | | | | | | |
| AB, DT, HGB, KNN, | 90.66 | 87.70 | 87.10 | 91.46 | 87.08 | 77.14 | 89.28 | 79.67 | 78.56 | 97.96 | 89.08 | 86.66 | Top-8 |
| LGBM, LR, MLP, RF | | | | | | | | | | | | | |
| AB, DT, HGB, KNN, | 90.49 | 88.03 | 87.10 | 91.11 | 87.12 | 77.19 | 89.10 | 79.60 | [symbol] | 97.92 | 89.02 | 86.59 | Top-9 |
| LGBM, LR, MLP, RF, | | | | | | | | | | | | | |
| SVC | | | | | | | | | | | | | |
| AB, DT, GB, HGB, | 90.25 | 87.48 | 86.69 | 91.01 | 86.70 | 76.52 | 88.85 | 78.98 | 77.71 | 97.78 | 88.76 | 86.20 | Top-10 |
| KNN, LGBM, LR, MLP, | | | | | | | | | | | | | |
| RF, SVC | | | | | | | | | | | | | |
| AB, DT, ET, GB, HGB, | 89.68 | 86.40 | 85.89 | 90.68 | 85.89 | 75.28 | 88.29 | 77.56 | 76.57 | 97.20 | 88.26 | 85.34 | Top-11 |
| KNN, LGBM, LR, MLP, | | | | | | | | | | | | | |
| SVC, XGB | | | | | | | | | | | | | |
| AB, DT, ET, GB, HGB, | 89.36 | 86.30 | 85.48 | 90.21 | 85.49 | 74.66 | 87.85 | 77.00 | 75.69 | 97.16 | 87.76 | 84.92 | All |
| KNN, LGBM, LR, MLP, | | | | | | | | | | | | | |
| RF, SVC, XGB | | | | | | | | | | | | | |

[symbol]

indicates data missing or illegible when filed

Expanding the investigation to combinations of classifiers, improvements in performance were observed when combining HGB with other high-performing models. Notably, the ensemble of AB, DT, HGB, MLP, SVC, and XGB emerged as the top performer among the top five combinations, boasting a mean score of 87.13. This highlights the synergistic effect of integrating complementary classifiers to achieve superior classification outcomes.

Table 8 presents a comprehensive analysis of the performance of the disclosed systems and methods across both the first and second stages, with and without error propagation.

TABLE 8
Comprehensive performance summary of the two-stage system, comparing results with and without
error propagation for both individual classifiers and the top classifier combinations.

| | | | | | | | | | | | | | | |
|---|---|---|---|---|---|---|---|---|---|---|---|---|---|---|
| | | | Accuracy | Precision | Recall | Specificity | F1 | IoU | BAC | MCC | Youden | Yule | AUC | Mean |
| Stage | Classifier | Scaler | ↑ | ↑ | ↑ | ↑ | ↑ | ↑ | ↑ | ↑ | ↑ | ↑ | ↑ | ↑ |

Individual

| | | | | | | | | | | | | | | |
|---|---|---|---|---|---|---|---|---|---|---|---|---|---|---|
| S1 | GB | None | 96.27 | 96.90 | 95.79 | 96.77 | 96.34 | 92.94 | 96.28 | 92.54 | 92.56 | 99.71 | 96.28 | 95.67 |
| S2 | DT | Robust | 91.00 | 86.35 | 86.21 | 93.11 | 86.19 | 76.00 | 89.66 | 79.46 | 79.32 | 97.73 | 89.19 | 86.75 |
| (Up) | | | | | | | | | | | | | | |
| S2 | HGB | MaxAbs | 89.68 | 85.97 | 85.89 | 91.25 | 85.90 | 75.30 | 88.57 | 77.44 | 77.14 | 96.96 | 88.91 | 85.73 |
| (Down) | | | | | | | | | | | | | | |

| | | | | | | | | | | | | |
|---|---|---|---|---|---|---|---|---|---|---|---|---|
| S1 + S2 | 95.18 | 86.17 | 86.05 | 97.00 | 86.05 | 75.66 | 91.53 | 83.15 | 83.05 | 99.02 | 91.27 | 88.56 |
| (With error | | | | | | | | | | | | |
| propagation) | | | | | | | | | | | | |
| S1 + S2 | 95.33 | 86.48 | 86.33 | 97.11 | 86.34 | 76.09 | 91.72 | 83.53 | 83.44 | 99.08 | 91.48 | 88.81 |
| (Without error | | | | | | | | | | | | |
| propagation) | | | | | | | | | | | | |

Combinations

| | | | | | | | | | | | | | |
|---|---|---|---|---|---|---|---|---|---|---|---|---|---|
| S1 | AB, GB, | 96.86 | 97.67 | 96.17 | 97.58 | 96.91 | 94.01 | 96.87 | 93.72 | 93.75 | 99.80 | 96.87 | [symbol] |
| | LGBM, LR | | | | | | | | | | | | |
| S2 | DT, KNN, | 92.63 | 89.17 | 88.89 | 93.80 | 88.73 | 79.88 | 91.34 | [symbol] | 82.68 | 98.83 | 90.86 | 88.93 |
| (Up) | LR, XGB | | | | | | | | | | | | |
| S2 | AB, DT, HGB, | 90.98 | [symbol] | 87.50 | 91.50 | 87.46 | 77.74 | 89.50 | 80.58 | 79.00 | 98.51 | 89.12 | 87.13 |
| (Down) | MLP, SVC, XGB | | | | | | | | | | | | |

| | | | | | | | | | | | | |
|---|---|---|---|---|---|---|---|---|---|---|---|---|
| S1 + S2 | 95.92 | 88.86 | 88.21 | 97.23 | 88.11 | 78.84 | 92.72 | 85.91 | 85.45 | 99.51 | 91.97 | 90.25 |
| (With error | | | | | | | | | | | | |
| propagation) | | | | | | | | | | | | |
| S1 + S2 | 95.85 | 88.70 | 88.03 | 97.20 | 87.95 | 78.56 | 92.62 | 85.70 | 85.24 | 99.49 | 91.94 | 90.12 |
| (Without error | | | | | | | | | | | | |
| propagation) | | | | | | | | | | | | |

[symbol]

indicates data missing or illegible when filed

When errors propagate from the first stage to the second, the performance metrics, such as accuracy, precision, recall, and F1-score, typically show a slight decrease. This happens because any misclassification in Stage 1 negatively impacts Stage 2, where the errors are passed along to the next step. In other words, when an incorrect prediction is made in Stage 1, it limits the potential accuracy and other performance measures for Stage 2. As seen in the Table 8, for instance, in the case of S1+S2 (With Error Propagation), the accuracy is 95.18 with an individual classifier and 95.92 with a combination of classifiers, which is slightly lower compared to the scenario without error propagation. Similarly, the F1-score and Recall are impacted, reflecting the chain reaction of misclassified instances leading to further errors downstream.

Error propagation is a significant challenge in multi-stage classification systems because it reduces the ability of the second stage to compensate for mistakes from the first stage. This also reflects a drop in metrics like MCC (Matthews Correlation Coefficient), which evaluates the overall performance in a balanced manner considering true and false positives/negatives.

Without error propagation, the second stage is more insulated from the errors of the first stage. This results in slightly improved performance metrics as the second classifier can independently evaluate its input without the weight of previous mistakes. For example, the accuracy for S1+S2 (Without Error Propagation) is 95.31 with an individual classifier and 95.85 with a combination of classifiers, showing a marginal improvement over the error-propagated case. Precision, Recall, and F1-score are also slightly higher compared to the case with error propagation, as the second stage can recover more effectively when working with error-free inputs.

The difference, while not dramatic, suggests that even small amounts of error propagation can affect overall classification performance. By avoiding error propagation, the system can maintain a more consistent level of accuracy and robustness across stages, especially in applications where even slight errors could accumulate and lead to significant degradation in performance.

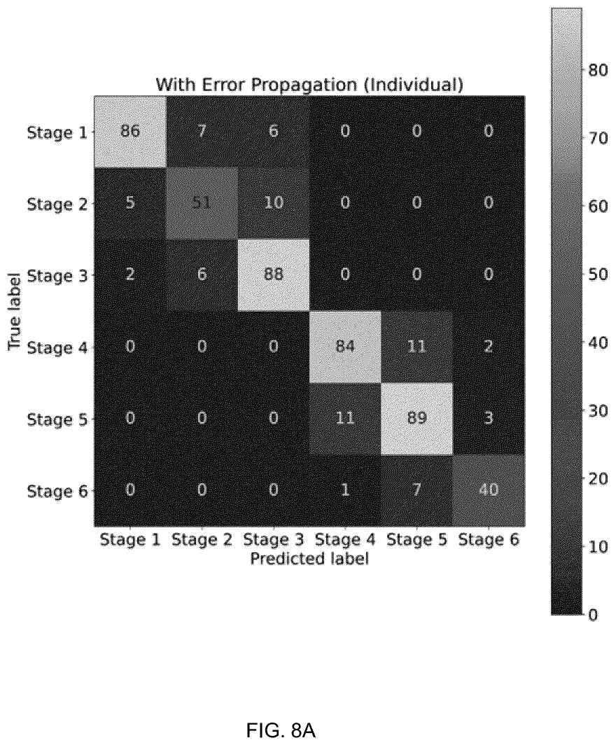

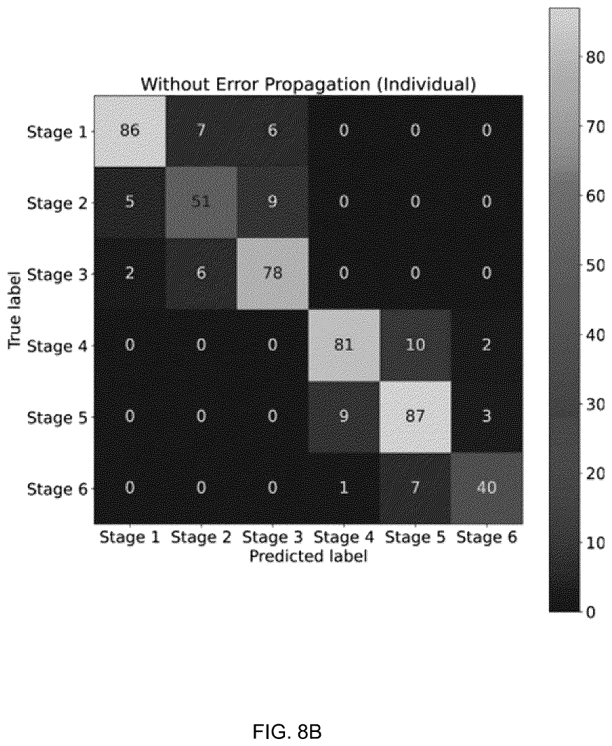

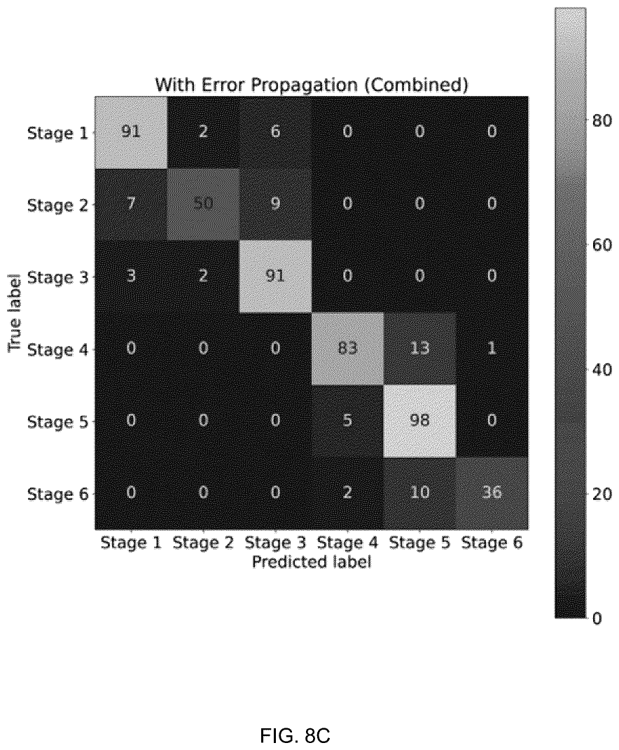

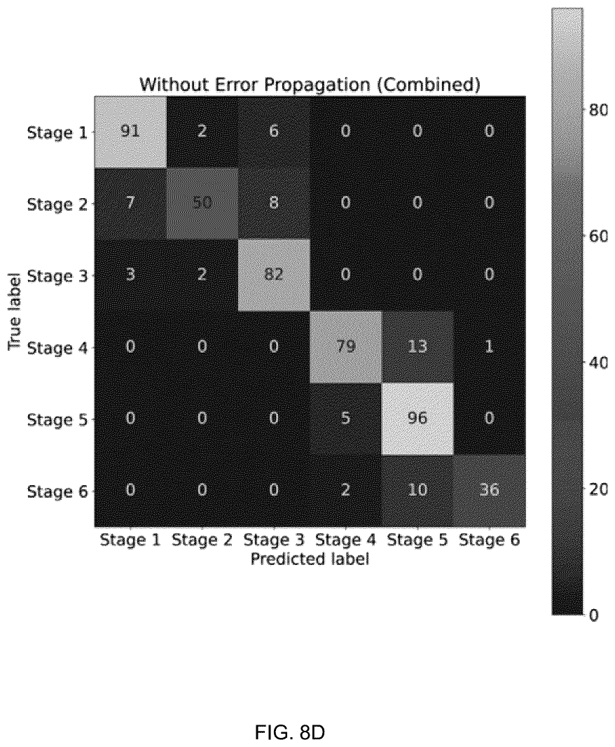

The analysis shown in Table 8 demonstrates that while the two-stage classification framework is robust, the introduction of error propagation can slightly reduce the overall performance. Without error propagation, the metrics are generally higher, suggesting that strategies to mitigate error propagation, such as better error-handling mechanisms or more independent stage classifiers, can yield improved outcomes. Nonetheless, the differences are relatively modest, indicating the system's general resilience, even with some degree of error propagation in place. The corresponding confusion matrices for the system using individual classifiers and combinations of classifiers and with and without error propagation are presented in FIGS. 8A-8D.

The source images used as training data are increased using data augmentation techniques on the source images, such as random rotation, flipping, zooming and shifting. These augmentations were incorporated to enhance the model's performance and further reduce the risk of overfitting. The results remained stable, as indicated in Table 9, reinforcing the strength of the disclosed system.

TABLE 9
Summary of the system's performance after applying data augmentation techniques.

| | | | | | | | | | | | | |
|---|---|---|---|---|---|---|---|---|---|---|---|---|
| | Accuracy | Precision | Recall | Specificity | F1 | IoU | BAC | MCC | Youden | Yule | AUC | Mean |
| Stage | ↑ | ↑ | ↑ | ↑ | ↑ | ↑ | ↑ | ↑ | ↑ | ↑ | ↑ | ↑ |

Individual

| | | | | | | | | | | | | |
|---|---|---|---|---|---|---|---|---|---|---|---|---|
| S1 + S2 | 98.61 | 96.15 | 96.07 | 99.12 | [symbol] | 92.46 | 97.59 | 95.25 | 95.19 | 99.95 | 97.54 | 96.73 |
| (With error propagation) | | | | | | | | | | | | |
| S1 + S2 | 98.68 | 96.22 | [symbol] | 99.16 | 96.22 | 92.74 | 97.69 | 95.44 | [symbol] | 99.95 | 97.62 | 96.85 |
| (Without error propagation) | | | | | | | | | | | | |

Combinations

| | | | | | | | | | | | | |
|---|---|---|---|---|---|---|---|---|---|---|---|---|
| S1 + S2 | [symbol] | 96.75 | 96.66 | [symbol] | [symbol] | 93.51 | 97.95 | 95.97 | 95.89 | 99.97 | 97.86 | 97.20 |
| (With error propagation) | | | | | | | | | | | | |
| S1 + S2 | 98.89 | 96.90 | 96.82 | 99.27 | 96.79 | [symbol] | 98.05 | 96.16 | [symbol] | 99.98 | 97.95 | 97.34 |
| (Without error propagation) | | | | | | | | | | | | |

[symbol]

indicates data missing or illegible when filed

While the source images used as the data set in development of this system are real clinical data, it is important to recognize the variability inherent in medical imaging, including differences in scanners and acquisition protocols, which can introduce noise and impact image quality. Such variability may affect the system's adaptability and generalization when applied in clinical environments.

To evaluate the specific impact of outlier detection and feature selection on system performance, the inventors conducted a comprehensive set of experiments in which these preprocessing techniques were intentionally excluded. The goal was to assess whether removing these steps would lead to a significant degradation in model performance, particularly in terms of accuracy. The results of these experiments, presented in Table 10, demonstrate that the system maintained a high level of performance, indicating its robustness to variations in the data. This robustness is largely attributed to the feature extraction process, which employs the marching level-sets approach to generate five iso-contours per segmented cervical vertebra, ensuring consistent feature representation despite potential noise or variability in the data. These findings suggest that the system's architecture, rather than reliance on outlier detection and feature selection, is the key driver of its strong performance, making it well-suited for real-world clinical applications

TABLE 10
Summary of the system's performance after removing feature selection and outlier detection.

| | | | | | | | | | | | | |
|---|---|---|---|---|---|---|---|---|---|---|---|---|
| | Accuracy | Precision | Recall | Specificity | F1 | IoU | BAC | MCC | Youden | Yule | AUC | Mean |
| Stage | ↑ | ↑ | ↑ | ↑ | ↑ | ↑ | ↑ | ↑ | ↑ | ↑ | ↑ | ↑ |

Individual

| | | | | | | | | | | | | |
|---|---|---|---|---|---|---|---|---|---|---|---|---|
| S1 + S2 | 95.85 | 88.26 | 88.02 | 97.30 | 87.92 | 78.57 | 92.66 | 85.53 | 85.31 | 99.39 | 92.24 | 90.09 |
| (With error propagation) | | | | | | | | | | | | |
| S1 + S2 | 95.80 | 88.12 | 87.85 | 97.30 | 87.78 | 78.33 | 92.58 | 85.36 | 85.15 | 99.36 | 92.23 | 89.99 |
| (Without error propagation) | | | | | | | | | | | | |

Combinations

| | | | | | | | | | | | | |
|---|---|---|---|---|---|---|---|---|---|---|---|---|
| S1 + S2 | [symbol] | 89.72 | 89.19 | 97.49 | 89.05 | 80.43 | 93.34 | [symbol] | 86.68 | 99.61 | 92.72 | 91.05 |
| (With error propagation) | | | | | | | | | | | | |
| S1 + S2 | 96.24 | 89.64 | 89.09 | 97.50 | [symbol] | 80.28 | 93.29 | 86.95 | 86.59 | 99.59 | 92.74 | 90.99 |
| (Without error propagation) | | | | | | | | | | | | |

[symbol]

indicates data missing or illegible when filed

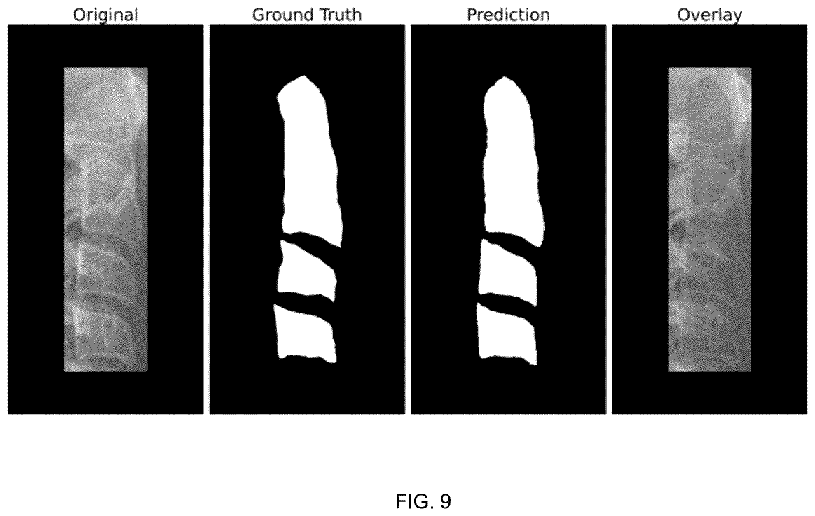

As previously mentioned, this invention employs a customized U-Net architecture for automating the task of segmentation. The segmentation experiment yielded a 93.52% intersection over union (IOU) and a 96.34% dice value. The utilized hyperparameters include: Adam as the parameter optimizer with a learning rate of 0.001, β1 of 0.9, and β2 of 0.999; Jaccard distance as the loss function; batch normalization; a 20% dropout ratio in the dropout layers; Sigmoid as the output activation function; ReLU as the hidden activation function; and avoidance of data augmentation to maintain the structure unchanged. FIG. 9 illustrates prediction results obtained from the customized U-Net architecture as compared to the original medical image, the specialist-designated ground truth, and the prediction results overlaid on the original medical image.

Table 9 presents a summary of performance metrics for various trials, including state-of-the-art models, applied to the entire dataset. The three approaches, Transformers (6 Classes—Images), Transformers (ROIs), and Transformers (Multi-Stage—Images), were evaluated for their performance on the dataset. The Google/ViT-base-patch16-224-in21k transformer model was utilized in all three approaches. In the first approach, Transformers (6 Classes—Images), the transformer model was trained to classify images into six different classes. The results show an accuracy of 77.55%, indicating that the model achieved a relatively good overall performance. However, the sensitivity (37.45%) and precision (51.10%) values suggest that the transformer model struggled to correctly identify instances from certain classes, leading to lower performance on those specific classes. The F1 score (30.10%) further confirms the model's limitations in handling imbalanced data and difficulty in capturing the characteristics of certain cervical vertebrae classes. Overall, the approach demonstrates potential but falls short of meeting the desired performance levels.

TABLE 9
Summary of performance metrics for various trials, including
state-of-the-art models, applied to the entire dataset.

| Approach | Accuracy | Sensitivity | Specificity | Precision | F1 | ROC | BAC | Means |
|---|---|---|---|---|---|---|---|---|
| Transformers (6 classes - Images) | 77.55 | 37.45 | 84.78 | 51.10 | 30.10 | 69.30 | 61.12 | 58.77 |
| Transformers (ROIs) | 75.58 | 32.21 | 83.67 | 43.89 | 23.76 | 67.64 | 57.94 | 54.96 |
| Transformers (Multi-stage - Images) | 77.34 | 37.08 | 84.73 | 62.19 | 27.51 | 71.29 | 60.90 | 60.15 |

In the second approach, Transformers (ROIs), the model was trained on region-of-interest (ROIs) extracted from the images. The results show an accuracy of 75.58%, slightly lower than the previous approach. The sensitivity (32.21%) and precision (43.89%) values indicate that the model faced challenges in correctly identifying relevant regions within the images, leading to lower performance. The low F1 score (23.76%) reflects the model's inability to effectively capture the information in the ROIs, resulting in reduced overall performance.

The third approach, Transformers (Multi-Stage-Images), employed a multi-stage classification strategy with two stages. In the first stage, the model combined the first three classes into one class, and the remaining three classes into another class. The second stage utilized an upper classifier to classify between the first three classes and a lower classifier to classify between the second three classes. The results showed an accuracy of 77.34%, which is similar to the first approach. However, the Sensitivity (37.08%) and Precision (62.19%) values indicate that the model achieved a higher Precision for the second set of classes, but the sensitivity remained low for both sets. The F1 score (27.51%) highlights the challenges in correctly classifying instances from both sets of classes.

The results demonstrate that the performance of all three approaches is poor compared to the system and method disclosed herein, which has results above 90%. The poor performance is evident in the low sensitivity values and the overall F1 scores, indicating difficulties in correctly identifying instances from specific classes. The transformer model may not be effectively capturing the underlying patterns and markers of the dataset, leading to suboptimal results.

The disclosed systems and methods may be embodied in computer program instructions stored on a non-transitory computer readable storage medium configured to be executed by a computing system. The computing system utilized in conjunction with the computer aided diagnostic system described herein will typically include a processor in communication with a memory, and a network interface. Power, ground, clock, and other signals and circuitry are not discussed, but will be generally understood and easily implemented by those ordinarily skilled in the art. The processor, in some embodiments, is at least one microcontroller or general purpose microprocessor that reads its program from memory. The memory, in some embodiments, includes one or more types such as solid-state memory, magnetic memory, optical memory, or other computer-readable, non-transient storage media. In certain embodiments, the memory includes instructions that, when executed by the processor, cause the computing system to perform a certain action. Computing system also preferably includes a network interface connecting the computing system to a data network for electronic communication of data between the computing system and other devices attached to the network. In certain embodiments, the processor includes one or more processors and the memory includes one or more memories. In some embodiments, computing system is defined by one or more physical computing devices as described above. In other embodiments, the computing system may be defined by a virtual system hosted on one or more physical computing devices as described above.

Various aspects of different embodiments of the present disclosure are expressed in paragraphs X1 and X2 as follows:
X1. One embodiment of the present disclosure includes a computer-aided system for classification of cervical vertebrae, the system comprising at least one non-transitory computer readable storage medium having computer program instructions stored thereon; and at least one processor configured to execute the computer program instructions causing the processor to perform the following operations: receiving medical image data including cervical vertebrae; extracting a plurality of regions of interest from the medical image data, wherein each of the plurality of regions of interest has a different level of granularity; extracting a plurality of markers from the plurality of regions of interest; classifying, using a machine learning classifier in a first stage of classification, the cervical vertebrae in one of a plurality of groups based at least in part on the extracted markers, each of the plurality of groups including a plurality of group members; and classifying, using a machine learning classifier in a second stage of classification, the cervical vertebrae as a specific member within the plurality of group members based at least in part on the extracted markers.
X2. Another embodiment of the present disclosure includes a method for classification of cervical vertebrae, the method comprising: receiving medical image data including cervical vertebrae; extracting a plurality of regions of interest from the medical image data, wherein each of the plurality of regions of interest has a different level of granularity; extracting a plurality of markers from the plurality of regions of interest; classifying, using a machine learning classifier in a first stage of classification, the cervical vertebrae in one of a plurality of groups based at least in part on the extracted markers, each of the plurality of groups including a plurality of group members; and classifying, using a machine learning classifier in a second stage of classification, the cervical vertebrae as a specific member within the plurality of group members based at least in part on the extracted markers.

Yet other embodiments include the features described in any of the previous paragraphs X1 or X2, as combined with one or more of the following aspects:

Wherein the plurality of groups include a first group and a second group.

Wherein the plurality of group members in the first group are earlier stages of cervical vertebrae maturation.

Wherein the plurality of group members in the second group are later stages of cervical vertebrae maturation.

Wherein classifying the cervical vertebrae as the specific member within the plurality of group members is classifying the cervical vertebrae as a specific stage of cervical vertebrae maturation within a plurality of stages of cervical vertebrae maturation.

Wherein the plurality of markers include at least one contour marker, at least one first order marker, and at least one second order marker.

Wherein the at least one contour marker is a plurality of contour markers.

Wherein the at least one contour marker is at least one of area, perimeter, centroid x-coordinate, centroid y-coordinate, radial distance from centroid, aspect ratio, convexity, compactness, extent, and solidity.

Wherein the at least one first order marker is at least one of mean, median, mean absolute deviation, robust mean absolute deviation, media absolute deviation, root mean square, variance, minimum, maximum, skewness, kurtosis, Shannon entropy, cumulative frequency, relative frequency, percentiles, interquartile range, mean x, mean y, standard deviation x, and standard deviation y.

Wherein the at least one second order marker is at least one of energy, energy SQRT, entropy, contrast, correlation, homogeneity, angular second moment, dissimilarity, inverse difference, cluster shade, cluster prominence, maximum probability, short run emphasis, long run emphasis, gray-level nonuniformity, run-length nonuniformity, run percentage, low gray-level run emphasis, high gray-level run emphasis, short run low gray-level emphasis, short run high gray-level emphasis, short run, long run low gray-level emphasis, and long run high gray-level emphasis.

Wherein the at least one second order marker is determined by at least one of Gray-Level Co-occurrence Matrix (GLCM) and Gray-Level Run-Length Matrix (GLRLM).

Wherein extracting the plurality of regions of interest from the medical image data includes, for each of the plurality of regions of interest, determining a boundary of the region of region of interest, and designating a threshold distance from the boundary, wherein each pixel in the medical image data within the threshold distance of the boundary constitutes the region of interest

Wherein each of the plurality of regions of interest has a different threshold distance.

Wherein extracting the plurality of markers from the plurality of regions of interest includes extracting the plurality of markers from each of the plurality of regions of interest.

Wherein the classifying using the machine learning classifier in the first stage of classification is determined by aggregating the outputs of multiple distinct machine learning classifiers.

Wherein the classifying using the machine learning classifier in the second stage of classification is determined by aggregating the outputs of multiple distinct machine learning classifiers.

Wherein the multiple distinct machine learning classifiers used in the first stage of classification are not identical to the multiple distinct machine learning classifiers used in the second stage of classification.

Wherein the system or method further comprises, after the extracting the plurality of markers, identifying pairs of highly correlated markers within the plurality of markers and removing one of each pair of highly correlated markers prior to the classifying using the machine learning classifier in a first stage of classification.

The foregoing detailed description is given primarily for clearness of understanding and no unnecessary limitations are to be understood therefrom for modifications can be made by those skilled in the art upon reading this disclosure and may be made without departing from the spirit of the invention.

1. A computer-aided system for classification of cervical vertebrae, the system comprising:
at least one non-transitory computer readable storage medium having computer program instructions stored thereon; and
at least one processor configured to execute the computer program instructions causing the processor to perform the following operations:
receiving medical image data including cervical vertebrae;
extracting a plurality of regions of interest from the medical image data, wherein each of the plurality of regions of interest has a different level of granularity;
extracting a plurality of markers from the plurality of regions of interest;
classifying, using a machine learning classifier in a first stage of classification, the cervical vertebrae in one of a plurality of groups based at least in part on the extracted markers, each of the plurality of groups including a plurality of group members; and
classifying, using a machine learning classifier in a second stage of classification, the cervical vertebrae as a specific member within the plurality of group members based at least in part on the extracted markers.

2. The computer-aided system of claim 1,
wherein the plurality of groups include a first group and a second group;
wherein the plurality of group members in the first group are earlier stages of cervical vertebrae maturation; and
wherein the plurality of group members in the second group are later stages of cervical vertebrae maturation.

3. The computer-aided system of claim 1, wherein classifying the cervical vertebrae as the specific member within the plurality of group members is classifying the cervical vertebrae as a specific stage of cervical vertebrae maturation within a plurality of stages of cervical vertebrae maturation.

4. The computer-aided system of claim 1, wherein the plurality of markers include at least one contour marker, at least one first order marker, and at least one second order marker.

5. The computer-aided system of claim 1, wherein extracting the plurality of regions of interest from the medical image data includes, for each of the plurality of regions of interest,
determining a boundary of the region of region of interest, and
designating a threshold distance from the boundary,
wherein each pixel in the medical image data within the threshold distance of the boundary constitutes the region of interest; and
wherein each of the plurality of regions of interest has a different threshold distance.

6. The computer-aided system of claim 1, wherein extracting the plurality of markers from the plurality of regions of interest includes extracting the plurality of markers from each of the plurality of regions of interest.

7. The computer-aided system of claim 1,
wherein the classifying using the machine learning classifier in the first stage of classification is determined by aggregating the outputs of multiple distinct machine learning classifiers;
wherein the classifying using the machine learning classifier in the second stage of classification is determined by aggregating the outputs of multiple distinct machine learning classifiers; and
wherein the multiple distinct machine learning classifiers used in the first stage of classification are not identical to the multiple distinct machine learning classifiers used in the second stage of classification.

8. The computer-aided system of claim 1, further comprising, after the extracting the plurality of markers, identifying pairs of highly correlated markers within the plurality of markers and removing one of each pair of highly correlated markers prior to the classifying using the machine learning classifier in a first stage of classification.

9. A method for classification of cervical vertebrae, the method comprising:
receiving medical image data including cervical vertebrae;
extracting a plurality of regions of interest from the medical image data, wherein each of the plurality of regions of interest has a different level of granularity;
extracting a plurality of markers from the plurality of regions of interest;
classifying, using a machine learning classifier in a first stage of classification, the cervical vertebrae in one of a plurality of groups based at least in part on the extracted markers, each of the plurality of groups including a plurality of group members; and
classifying, using a machine learning classifier in a second stage of classification, the cervical vertebrae as a specific member within the plurality of group members based at least in part on the extracted markers.

10. The method of claim 9,
wherein the plurality of groups include a first group and a second group;
wherein the plurality of group members in the first group are earlier stages of cervical vertebrae maturation; and
wherein the plurality of group members in the second group are later stages of cervical vertebrae maturation.

11. The method of claim 9, wherein classifying the cervical vertebrae as the specific member within the plurality of group members is classifying the cervical vertebrae as a specific stage of cervical vertebrae maturation within a plurality of stages of cervical vertebrae maturation.

12. The method of claim 9, wherein the plurality of markers include at least one contour marker, at least one first order marker, and at least one second order marker.

13. The method of claim 9, wherein extracting the plurality of regions of interest from the medical image data includes, for each of the plurality of regions of interest,
determining a boundary of the region of region of interest, and
designating a threshold distance from the boundary,
wherein each pixel in the medical image data within the threshold distance of the boundary constitutes the region of interest; and
wherein each of the plurality of regions of interest has a different threshold distance.

14. The method of claim 9, wherein extracting the plurality of markers from the plurality of regions of interest includes extracting the plurality of markers from each of the plurality of regions of interest.

15. The method of claim 9,
wherein the classifying using the machine learning classifier in the first stage of classification is determined by aggregating the outputs of multiple distinct machine learning classifiers;
wherein the classifying using the machine learning classifier in the second stage of classification is determined by aggregating the outputs of multiple distinct machine learning classifiers; and
wherein the multiple distinct machine learning classifiers used in the first stage of classification are not identical to the multiple distinct machine learning classifiers used in the second stage of classification.

16. The method of claim 9, further comprising, after the extracting the plurality of markers, identifying pairs of highly correlated markers within the plurality of markers and removing one of each pair of highly correlated markers prior to the classifying using the machine learning classifier in a first stage of classification.
